(19) United States
(12) Patent Application Publication
(10) Pub. No.: US 2023/0213913 A1
(43) Pub. Date: Jul. 6, 2023

(54) Creating 3D Objects and Digital 3D Objects

(71) Applicant: Illusory Material, Inc., Belmont, CA (US)

(72) Inventors: Jiani Zeng, San Francisco, CA (US); Honghao Deng, San Francisco, CA (US)

(73) Assignee: Illusory Material, Inc., Belmont, CA (US)

(21) Appl. No.: 18/093,439

(22) Filed: Jan. 5, 2023

Related U.S. Application Data
(60) Provisional application No. 63/297,075, filed on Jan. 6, 2022.

(51) Int. Cl. G05B 19/4099; G06T 15/06; G06T 17/20; G06T 19/20; B33Y 50/00; B33Y 80/00; A23G 3/56; A23G 3/54; G02B 27/00; G02B 3/00

(52) U.S. Cl. CPC G05B 19/4099; G06T 15/06; G06T 17/20; G06T 19/20; B33Y 50/00; B33Y 80/00; A23G 3/56; A23G 3/54; G02B 27/0012; G02B 3/005; G02B 3/0012; G06T 2210/16; G06T 2219/021; G06T 2219/008; G06T 2219/2012; G05B 2219/35134; G02B 30/27

(57) ABSTRACT

The disclosure includes an object comprising a front lens layer made from at least one of transparent material or translucent material, having a lens with curved surfaces that provide refractive behaviors and a backing layer embedded with patterns. The disclosure also includes a method for designing an object with lenticular effects. The disclosure further includes a method for designing a textile for 3D printing. The disclosure also includes a candy or lollipop comprising a front layer comprising a plurality of at least one of elongated or standalone transparent geometries with defined heights, curvatures and shapes that provide refractive behaviors and a backing layer with at least one of colors or patterns. The disclosure also includes barrier-based object designs that create optical illusions.

### CROSS REFERENCE TO RELATED APPLICATIONS

This application claims priority to, and the benefit of, U.S. Provisional Ser. No. 63/297,075 filed on Jan. 6, 2022 and entitled “Method and Apparatus for Creating 3D Objects with Lenticular Surfaces,” the entire contents of which is hereby incorporated by reference in its entirety for all purposes.

### FIELD

This disclosure generally includes methods and apparatus for creating 3D objects and digital 3D objects with viewpoint dependent optical illusions, and more particularly, methods and apparatus for producing lens-covered and barrier-based 3D objects with lenticular or changeable picture appearance.

### BACKGROUND

Many technologies currently exist for producing flat or simply curved objects and displays with depth illusions (three-dimensional effects) or to reveal independent images under different viewpoints. Two broad approaches may currently be used to accommodate parallax and multi-view displays namely, lens-based methods and barrier-based methods.

A lens-based method typically includes a lens array positioned on top of an image layer. When viewed from various viewpoints, the light refracted by the lenses allows individuals to perceive different portions of the interlaced image beneath the lenses. Two main categories of lens configurations based on lens geometry and distribution exist, namely lenticular lenses and fly's eye lenses (also known as integral lenses). Lenticular lenses are typically long, narrow cylindrical lenses arranged in an array, while fly's eye lenses are typically spherical lenses arranged in an array. Both lenticular and integral imaging techniques may be used in the 3D display industry for parallax displays. Displays using cylindrical lens arrays (known as lenticular panoramagrams) display only horizontal parallax, while displays using spherical lens arrays (known as integral photographs or integrams) provide both horizontal and vertical directional information to create a full parallax image (Halle, M. (1997). Autostereoscopic Displays and Computer Graphics. Computer Graphics, ACM Siggraph, vol. 31, no. 2, 1997, pp. 58-62.). In the display industry, lenticular imaging is more commonly used due to its higher spatial resolution, while the directional information provided by integral imaging is less important in typical use cases (Ibid). In the hardcopy printing industry, lenticular methods are more widely adopted than integral methods. A popular technique is lenticular printing, which typically involves combining pre-made flat lenticular sheets with 2D color patterns made up of multiple images. Fly's eye lens sheets (which can be used to create 3D integral images) are less common due to their lower spatial resolution sacrificed to directional information. As used herein, the term “lenticular” is broadly defined and can refer to both cylindrical and spherical lens arrays. The term “lenticular effect” is also used to describe any optical illusions created by individual lenses (lenticules) placed on top of a composite of two or more interlaced graphics. Some of the most popular lenticular effects include, for example, 3D, morph, animation, flip, and zoom.

A barrier-based method typically involves using an opaque layer or slits to block certain parts of an underlying image. In the 3D display industry, autostereoscopic effects can be achieved through the use of a parallax barrier. Parallax barrier may comprise a layer with tiny, precisely spaced slits that separates two sets of pixels. Each eye sees a different set of pixels, creating the illusion of depth through the effect of parallax. In the movie and printing industries, moving picture or color shifting effects can be achieved through barrier-grid animation. Barrier-grid animation is typically created by sliding a transparent overlay with stripes over an interlaced image. In the art and printing industries, the “Agamograph” is a form of kinetic art that uses optical illusion to create dynamic artwork that appears to change when viewed from different angles. Inspired by the barrier grid, Agamographs do not typically use lenses, but rather employ the insertion of different colors and images on surfaces facing different angles to produce radically different images from various viewpoints.

The methods and techniques described above are all used to create optical illusions on flat or simply curved surfaces, displays, or objects. These techniques are suitable for creating depth illusions or autostereoscopic displays on 2D surfaces. However, none of these existing techniques can be used to produce kinetic optical illusions on 3D objects or doubly curved surfaces in the context of creating multi-view changeable images.

Conventional 2D lenticular printing has limitations. For example, the color/pattern shifting effect and quality of optical aberrations are often highly restricted by current manufacturability in optical lens and printer resolution. Mass-produced lenticular sheets are typically rigid flat with production standards such as, for example, fixed lens curvature, thickness and refractive index. The sheet might be bended and covers simply curved surfaces, but the sheet cannot be mapped onto doubly curved ones. For example, the making of a lenticular sheet and content images are separate and handled by different people or companies. The designer/end user has to create the 2D patterns following the exact format or instruction that works with the lenticular sheets. The number of embedded images, image size and qualities all fit into presets or templates, and are limited by lens size and printer resolution. Additionally, image data can only be designed and produced in 2D and the resulting lenticular effect may be viewed in a linear viewing path, otherwise the end user may see a broken or discontinuous lenticular effect.

Conventional barrier-based methods (such as parallax barrier and barrier-grid animation) have the limitation of halving the horizontal pixel count viewable by each eye, which reduces the overall horizontal resolution of the image. Agamographs has a limited number of image frames, typically with two interlaced images inserted into two different viewpoints, due the accordion shaped image layer.

Both lens-based and barrier-based methods for creating multi-view optical illusions have yet to be implemented on 3D objects due to technical barriers and the lack of efficient workflow. An example of a technical barrier is related to manufacturability. In lenticular printing, there was previously no suitable fabrication or manufacturing technology that could produce highly transparent geometry and high-resolution color patterns on doubly curved surfaces until recent development of multi-material 3D printing (such as Polyjet technology which can print voxel level clear materials as well as CMYK materials). Similarly, methods like Agamographs that rely on cutting or folding patterned flat paper to create multiple surfaces facing different angles are difficult to apply to complex 3D geometries. Applying images or colors to fully cover the exposed surfaces of complex 3D geometries with convex or concave patterns can also be challenging. Existing techniques such as spraying or printing may also be difficult to use in this context. Additionally, there was no workflow or method to compute and digitally model 3D objects or surfaces with multi-view optical illusions. In lens-based methods, no prior workflow is found to generate lenticular or fly's eye lenses on 3D surface to achieve desired effects. Therefore, it was not possible to map lenses and apply color-shifting optical effects on free-form 3D objects, for both physical objects and digital CAD models. For barrier-based methods, there is currently no sufficient workflow or software available that is specifically designed to assign different colors or interlace images onto specific areas of a complex 3D geometry in a way that allows people to view different images from different perspectives.

A strong need exists for a 3D object or surface with changeable multi-view displays. A strong need also exists for a workflow or method for creating a 3D object or surface with desired optical illusion effects.

### SUMMARY

The disclosure includes methods and systems for applying optical illusion effects (e.g. lenticular effects, reflective and light-distorting appearance) to any surface of any object. By manipulating the optical properties of an object, the disclosure allows for the creation of a range of visual effects, such as changes in color, depth, or perspective. In various embodiments, the disclosure is particularly useful for creating 3D objects with complex, doubly curved surfaces. The ability to apply the lenticular effect on various forms opens up a wide range of possibilities for designers and creators.

In various embodiments, the disclosure allows the whole design of the front layer and backing layer to be simultaneously handled in the same system or by the same company or person, which provides greater control and flexibility for designers and ensure that the final product is consistent and meets their specific requirements. In various embodiments, the disclosure also provides designers with more control over the lens geometry, size, and fabrication method, enabling designers to experiment with different shapes and depths of the lens, surface form, and maximum viewing angle of the image frames. The disclosure also allows for more freedom in locating and designing each patterned region or content under the lens layer, as well as in controlling the transparency and hardness of the image data. Additionally, the ability to design three-dimensional image data gives designers even more freedom in their creative process.

In various embodiments, the disclosure pertains to defining structures and properties to create 3D objects with multi-view displays, as well as to methods for designing and producing such objects. Examples of multi-view 3D objects include lens-based and barrier-based displays that create optical illusions.

In various embodiments, a method is provided for determining lens geometry and image data using ray tracing. The method includes steps for determining lens locations, which may be based on various distribution methods such as parallel, concentric, or following surface curvatures (such as using UV curves or mesh vertices). The method also includes steps for determining lens geometry and applying patterns to the area under each lens using ray tracing from multiple viewpoints.

In various embodiments, the disclosure includes a ray tracing method to determine 3D element geometry and surface pattern of a barrier-based 3D object. The method includes determine 3D element locations. This step may be based on different 3D element distribution methods, such as parallel distribution, concentric distributions, distribution follows surface curvatures like UV curves or mesh vertices, etc. The method also includes determine 3D element geometry. The method also includes determine and apply patterns to the area under each lens using ray tracing from different viewpoints.

In various embodiments, the disclosure includes a method for creating viewpoint dependent objects that reveal different contents based on a variety of pre-defined patterns of different viewing angles. For lens-based 3D objects, in various embodiments, the method includes steps for determining a set of 2D images to be revealed at different viewpoints, placing virtual cameras to represent these viewpoints, and using ray tracing to determine the sizes, shapes, and locations of focal windows under each lens at each viewpoint. In various embodiments, the method includes a step for patterning the defined focal lenses with images derived from the pre-selected 2D images. For barrier-based 3D objects, the method includes projecting an image onto the surfaces of 3D elements from a specific viewpoint.

In various embodiments, the methods and systems are provided for customizing the geometry and properties of an object to create unique and visually striking designs using a wider range of materials, including soft and rigid materials. In various embodiments, the disclosure may be used in conjunction with 3D printing to provide greater flexibility and customization in the design process. In other embodiments, the disclosure may be used in conjunction with precision glass moulding and CNC techniques to enhance the accuracy and quality of the final design. In other embodiments, the disclosure may be used for printing directly on fabrics.

In various embodiments, a method is provided for designing fibers on a fabric with an optical illusion display. The method includes steps for determining the locations, distributions, geometries, orientations, and patterns of the 3D fibers. The method also includes a step for generating the 3D fibers. In various embodiments, the fibers may be designed to follow the curvature of a specific shape, such as a human body shape, using techniques such as UV mapping and unwrapping.

In various embodiments, the disclosure provides a lenticular candy design. The candy may include a front layer made from transparent material (e.g sugar glass) which covers a backing layer. The front layer comprises an array of elongated or integral lenses with different heights, curvatures and shapes that provide different refractive behaviors. Different color pixels/patterns/strips embedded in the backing layer reveal at different viewpoints.

### BRIEF DESCRIPTION OF THE DRAWINGS

FIG. 1 is an exemplary schematic diagram of a possible structure of a flat lenticular object, in accordance with various embodiments.

FIG. 2 is an exemplary schematic diagram of a possible structure of a 3D lenticular object, in accordance with various embodiments.

FIG. 3 is an exemplary schematic diagram of a possible structure of a 3D object covered with standalone spherical lenses, in accordance with various embodiments.

FIG. 4 is an exemplary schematic diagram of a possible structure of a 3D textile covered with standalone spherical lenses, in accordance with various embodiments.

FIG. 5 is an exemplary schematic diagram to show the basic parameters that define a lens geometry and ray tracing principles, in accordance with various embodiments.

FIG. 6 is an exemplary schematic diagram to show the focal window's size and location in relation to lens geometry and viewpoints, in accordance with various embodiments.

FIG. 7 is a selection of exemplary section views of lens geometry design, in accordance with various embodiments.

FIG. 8 is a selection of exemplary section views of lens design with its backing layer in different forms, in accordance with various embodiments.

FIG. 9 is a selection of exemplary top views of a backing layer with embedded patterns, in accordance with various embodiments.

FIG. 10 is an exemplary schematic diagram to show the lens geometry design with maximum viewing angle, where the extreme ray entering from one edge of the lenticule is refracted to reach the opposite edge of the image strip, in accordance with various embodiments.

FIG. 11 is an exemplary schematic diagram of a possible structure of a flat barrier-based object, in accordance with various embodiments.

FIG. 12 is an exemplary schematic diagram of a possible structure of a barrier-based 3D object covered with elongated 3D stripes, in accordance with various embodiments.

FIG. 13 is an exemplary schematic diagram of a possible structure of a barrier-based 3D object covered with standalone 3D elements, in accordance with various embodiments.

FIG. 14 is an exemplary schematic diagram of a possible structure of a barrier-based 3D textile covered with standalone 3D elements, in accordance with various embodiments.

FIG. 15 is a selection of exemplary section views of 3D element geometry designs of a barrier-based 3D object, in accordance with various embodiments.

FIG. 16 is an exemplary positive multi-faced 3D element of a barrier-based 3D object to illustrate the general rules and methods of color assignment on the surfaces of a 3D element, in accordance with various embodiments.

FIG. 17 is an exemplary positive 3D element with smooth surfaces, in accordance with various embodiments.

FIG. 18 is an exemplary negative multi-faced 3D element of a barrier-based 3D object, in accordance with various embodiments.

FIG. 19 is an exemplary negative 3D element with smooth surfaces, in accordance with various embodiments.

FIG. 20 is a block diagram of an exemplary computer system, in accordance with various embodiments.

FIG. 21 is a block diagram of an exemplary workflow for designing and creating a lens-based 3D object for multi-view displays, in accordance with various embodiments.

FIG. 22 is an exemplary schematic diagram to show the general structure for an exemplary 3D lenticular object with a parallel lens distribution, in accordance with various embodiments.

FIG. 23A is a schematic and flow diagram to show the design process for an exemplary 3D lenticular object with a parallel lens distribution, in accordance with various embodiments.

FIG. 23B is a block diagram to show the design process for an exemplary 3D lenticular object with a parallel lens distribution, in accordance with various embodiments.

FIG. 24 is a rendering of an exemplary 3D lenticular object with a parallel lens distribution from different viewpoints, in accordance with various embodiments.

FIG. 25A is an exemplary schematic diagram of an exemplary 3D lenticular object with lenses arranged in a concentric configuration, in accordance with various embodiments.

FIG. 25B is an exemplary schematic diagram of to show the sectional structure of an exemplary 3D lenticular object with lenses arranged in a concentric configuration, in accordance with various embodiments.

FIG. 26 is an exemplary schematic diagram of to show different concentric lens distributions on exemplary 3D lenticular object with asymmetric geometry, in accordance with various embodiments.

FIG. 27A is a schematic and flow diagram to show the design process for an exemplary 3D lenticular object with a circular pattern lens distribution, in accordance with various embodiments.

FIG. 27B is a block diagram to show the design process for an exemplary 3D lenticular object with a circular pattern lens distribution, in accordance with various embodiments.

FIG. 28A is an exemplary schematic diagram of a possible structure of a 3D lenticular object with a circular pattern lens distribution, in accordance with various embodiments.

FIG. 28B is an exemplary section view of a possible structure of a 3D lenticular object with a circular pattern lens distribution, in accordance with various embodiments.

FIG. 29 is a rendering of an exemplary 3D lenticular object with a circular pattern lens distribution from different viewpoints, in accordance with various embodiments.

FIG. 30 an exemplary schematic diagram to show the internal and lens structure of a loop-like geometry covered with lenses in a circular pattern distribution, in accordance with various embodiments.

FIG. 31 an exemplary schematic diagram to show the general steps to create a loop-like geometry covered with lenses in a circular pattern distribution, in accordance with various embodiments.

FIG. 32 an exemplary schematic diagram of a 3D lenticular object with lenses distributed on a spread surface, in accordance with various embodiments.

FIG. 33A is a schematic and flow diagram to show the design process for an exemplary 3D lenticular object with UV mapped lenses, in accordance with various embodiments.

FIG. 33B is a block diagram to show the design process for an exemplary 3D lenticular object with UV mapped lenses, in accordance with various embodiments.

FIG. 34 is a rendering of three lenticular objects designed with the process in FIGS. 33A and 33B, in accordance with various embodiments.

FIG. 35A is a schematic and flow diagram to show a UV-based design process for an exemplary 3D object with dotted lenses arranged in a grid, in accordance with various embodiments.

FIG. 35B is a block diagram to show a UV-based design process for an exemplary 3D object with dotted lenses arranged in a grid, in accordance with various embodiments.

FIG. 36A is a schematic and flow diagram to show a mesh triangulation-based design process for an exemplary 3D object with dotted lenses arranged in a grid, in accordance with various embodiments.

FIG. 36B is a block diagram to show a mesh triangulation-based design process for an exemplary 3D object with dotted lenses arranged in a grid, in accordance with various embodiments.

FIG. 37 is a rendering of the original base geometry, the backing layer with patterned regions and the final lens-based 3D object with dotted lenses arranged in a grid, in accordance with various embodiments.

FIG. 38 is a few images of an exemplary lens-based 3D object with dotted lenses printed using flexible materials, in accordance with various embodiments.

FIG. 39 an exemplary schematic diagram to explain basic rules in ray tracing and light refractions from different viewpoints, in accordance with various embodiments.

FIG. 40 is a block diagram to show the overall workflow for creating a lens-covered object with viewpoint-dependent display, in accordance with various embodiments.

FIG. 41A is an exemplary schematic diagram to show the 3 images to be revealed at 3 viewpoints, in accordance with various embodiments.

FIG. 41B is an exemplary schematic diagram of segmenting images and assign to different viewpoints, in accordance with various embodiments.

FIG. 41C is an exemplary schematic diagram of the resulting base layer with patterned regions derived from the 3 images assigned to each lens area, in accordance with various embodiments.

FIG. 42 is a block diagram to show an exemplary process of creating a barrier-based object with 3D elongated stripes, in accordance with various embodiments.

FIG. 43 is an exemplary schematic diagram of different methods to segment a geometry into sections, in accordance with various embodiments.

FIG. 44A is a schematic and flow diagram to show design process for an exemplary barrier-based 3D object with standalone 3D elements dispersed over the surface, in accordance with various embodiments.

FIG. 44B is a block diagram to show design process for an exemplary barrier-based 3D object with standalone 3D elements dispersed over the surface, in accordance with various embodiments.

FIG. 45 is an exemplary schematic diagram of an exemplary barrier-based 3D object with colors assigned to different surfaces of each 3D stripe, in accordance with various embodiments.

FIG. 46 is an exemplary schematic diagram of an exemplary barrier-based 3D object with a pattern projected to multiple surfaces of 3D stripes, from a specific viewpoint, in accordance with various embodiments.

FIG. 47 is an exemplary schematic diagram of an exemplary barrier-based 3D object with colors assigned to different surfaces of a few selected 3D elements, in accordance with various embodiments.

FIG. 48 is an exemplary schematic diagram of an exemplary barrier-based 3D object with a pattern projected to multiple surfaces of 3D elements, from a specific viewpoint, in accordance with various embodiments.

FIG. 49 is a block diagram of an exemplary process for using 3D printing to produce a multi-view 3D object, in accordance with various embodiments.

FIG. 50A is an exemplary schematic diagram of an exemplary lens-based textile in a flat form, in accordance with various embodiments.

FIG. 50B is an exemplary schematic diagram of an exemplary lens-based textile in a 3D form, in accordance with various embodiments.

FIG. 51A is an exemplary schematic diagram of an exemplary barrier-based textile in a flat form, in accordance with various embodiments.

FIG. 51B is an exemplary schematic diagram of an exemplary barrier-based textile in a 3D form, in accordance with various embodiments.

FIG. 52 is a block diagram of an exemplary process for generating a design featuring 3D fibers arranged on a flat surface, in accordance with various embodiments.

FIG. 53 is a block diagram of an exemplary process for generating a multi-view 3D textile design that follows curved surfaces, which includes flattening geometry near the end of the process, in accordance with various embodiments.

FIG. 54 is a block diagram of an exemplary process for generating a multi-view 3D textile design that follows curved surfaces, which includes flattening geometry near the beginning of the process, in accordance with various embodiments.

FIG. 55A is an exemplary schematic diagram to show the lenticular display of a pen at correct sitting posture, in accordance with various embodiments.

FIG. 55B is an exemplary schematic diagram to show the lenticular display of a pen at incorrect sitting posture, in accordance with various embodiments.

FIG. 56A is a picture of the front view of an exemplary packaging design using lenticular lens design to hide product information, in accordance with various embodiments.

FIG. 56B is a picture of the tilted view of an exemplary packaging design using lenticular lens design to show product information, in accordance with various embodiments.

FIG. 57 is an exemplary schematic diagram to show the internal structure of an exemplary packaging design using lenticular lens design, in accordance with various embodiments.

FIG. 58A is an exemplary schematic line drawing of an exemplary lenticular lollipop design in perspective view, in accordance with various embodiments.

FIG. 58B is an exemplary schematic diagram to show the internal structure of an exemplary lenticular lollipop design, in accordance with various embodiments.

FIG. 59 is a picture of three exemplary lenticular lollipop designs viewed at three perspectives, in accordance with various embodiments.

### DETAILED DESCRIPTION

The disclosure includes methods for designing and producing the structures and properties of 3D objects with multi-view displays. The 3D objects may include one or more of viewpoint dependent displays, multi-view displays, optical illusions, kinetic optical displays, integral displays and/or lenticular displays. The disclosure may also include creating kinetic optical 3D objects. Examples of multi-view 3D objects include lens-based and barrier-based displays that create optical illusions. The disclosure also includes methods for designing and distributing elements that contribute to the optical effects on a 3D geometry, and to methods for producing physical 3D objects or textiles with optical illusion displays. Additionally, the disclosure pertains to the creation of viewpoint-dependent 3D objects that display a specific image at desired viewpoints. As used herein, “object” includes one or more of any item, sculpture, vase, food, candy, lollipop, textile or digital object of any shape or size.

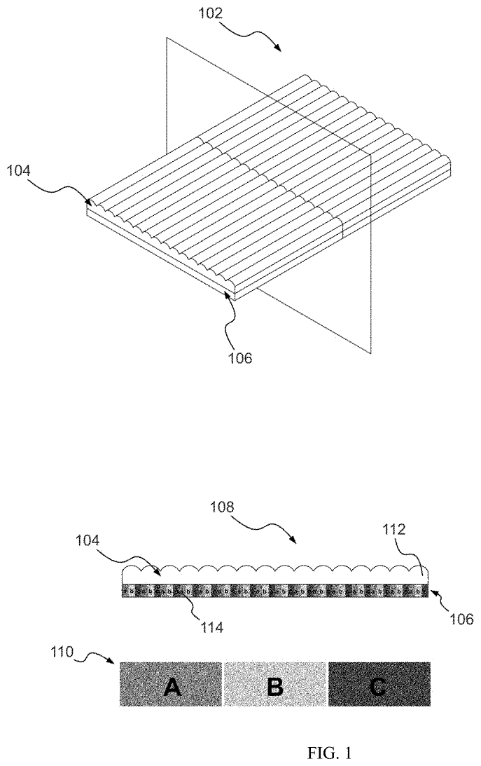

With respect to the types of lens-based 3D objects for multi-view displays, as set forth in FIG. 1, a traditional flat lenticular card 102 may include a front layer (also referred as “film”) 104 of cylindrical lens array, typically made from clear polypropylene (PP) or polyethylene terephthalate (PET), and a backing layer 106 with embedded image data. As set forth in more detail in the section view of the flat lenticular card 108, the lens array comprises a plurality of lenticules 112; in the backing layer 106, two or more interlaced graphics comprising a plurality of colored pixels 124 are under each lenticule 112. Different color pixels 124 can be revealed in different viewpoints. Designers may embed a plurality of image frames 110 by segmenting the frames and distributing them in the backing layer 106. In various embodiments, the proposed system allows creating objects like the flat lenticular card 102.

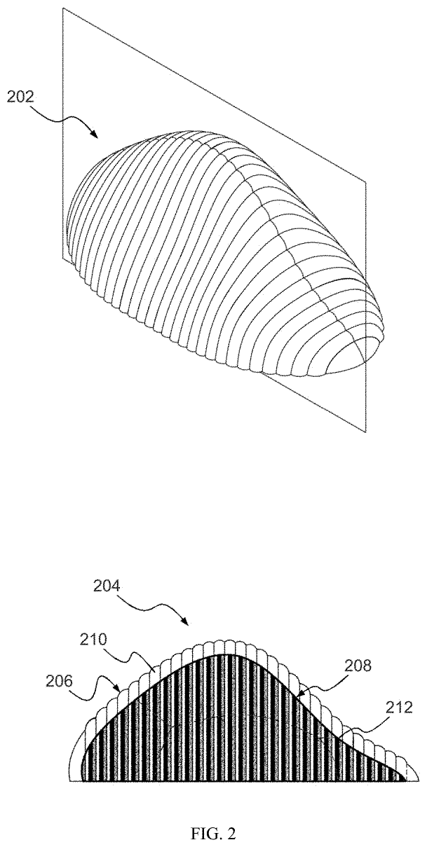

As set forth in more detail in FIG. 2, in various embodiments, the lenticular 3D object may be a complex 3D geometry 202. As displayed in the section view of the lenticular object 204, the lenticular object may include a front layer 206 made from transparent material which covers a backing layer 208. Both front and backing layer may have complex geometry. The front layer 206 comprises one or more arrays of elongated lenses 210 with different heights, curvatures and shapes that provide different refractive behaviors. Different color pixels 212 embedded in the backing layer 208 may reveal at different viewpoints. As used herein, “elongated” lenses may include a cylindrical shape or any other shape that may not be cylindrical and may include with different heights, curvatures and shapes.

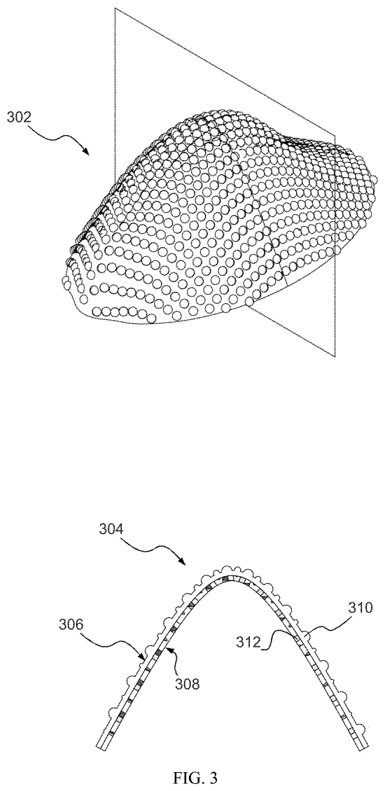

As set forth in FIG. 3, in various embodiments, a lens covered 3D object may be a complex 3D geometry 302. As used herein, a “lens covered 3D object” may include a lenticular object, but also may include any other shape that is not necessarily long and narrow. As displayed in the section view of the lens overed object 304, the lens covered object may include a front layer 306 made from transparent material which covers a backing layer 308. Both front layer 306 and backing layer 308 may have complex geometry. The front layer 306 comprises an array of integral lenses 310 with different heights, curvatures and shapes that provide different refractive behaviors. Different color pixels 312 embedded in the backing layer 308 may reveal at different viewpoints. As used herein, “integral lenses” may include the shape in FIG. 3 or any of the other figures, or any other shape such as, for example, square, rectangular, or free form shapes.

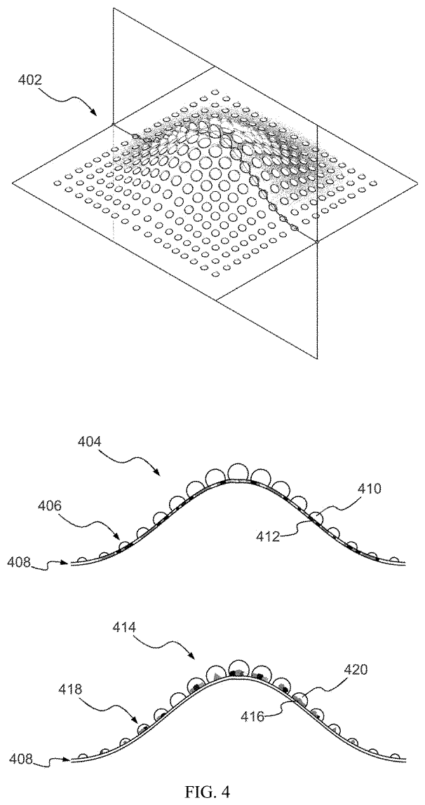

As set forth in FIG. 4, in various embodiments, a plurality of lenses may be applied to the surface of a fabric 408 to create a lens covered textile 402. The lens covered textile 402 includes a front layer 406 comprises a plurality of individual lenses 410.

In various embodiments, a lenticular textile 402 is created by applying a plurality of lenses to the surface of a fabric 408. The disclosure allows designers to program lens density into the fabric, which affects the drape of the fabric. The size and arrangement of the lenses on the fabric affects the flexibility and visual appearance of the fabric. For instance, areas with lower spatial density and larger, coarser lenses are more rigid and have a calmer visual appearance; while areas with higher spatial density and smaller, finer lenses will be more flexible and have a more dynamic visual appearance. Patterns and image data may be embedded either in the fabric or the front lens layer. Section view 404 of the textile 402 shows that patterns 412 may be embedded in the fabric 408. In various embodiments, the patterns 412 may be sewed or printed to the fabric 408. The front layer 406 on top of the fabric 408 may include a plurality of individual lenses with varying sizes, heights, stiffness and spatial density. Section view 414 of the textile 402 shows that patterns 416 are embedded in the lenses 420, a plurality of lenses embedded with patterns constitute a front layer 418. In various embodiments, the patterns 416 and the transparent parts of lens 420 may be produced in a single material layer using technique like multi-material 3D printing.

In various embodiments, the textile 402 may be further made into clothing, garments, accessories and etc. to display a unique visual dynamism when the fabric drapes.

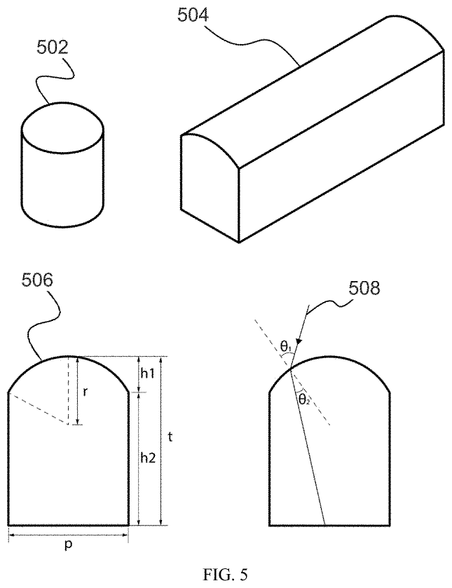

With respect to structures and rules of lens-based 3D objects for multi-view displays, as set forth in FIG. 5, a standard lenticule or lens geometry may be characterized by several parameters. For example, a standard spherical lenticule 502 or cylindrical lenticule 504 may comprise a cross-section 506 where “t” is the lenticule/lens thickness; “p” is the lenticule/lens pitch, or width of each lenticular cell; “r” is the radius of the curvature of the lenticule/lens; “h₁” is the height of the curvature of the lenticule/lens; and “h₂” is the thickness of the substrate below the curved surface of the lens or cuboid thickness.

Each standard spherical lenticule 502 may comprise a thin spherical section and a solid cuboid;

Each standard cylindrical lenticule 504 may comprise a thin cylindrical section and a solid cuboid. The path of a ray 508 bends when it travels from a transparent substance (e.g. air) into another (e.g. resin, glass). Light traveling through optics follows Snell's Law, which states that the ratio of the sines of the angle of incidence (θ₁) and the angle of refraction (θ₂) is equal to the ratio of the refractive indices (n₂/n₁) of the two media, where “n₂” is the refraction index of the lens; and “n₁” is the refraction index of the air.

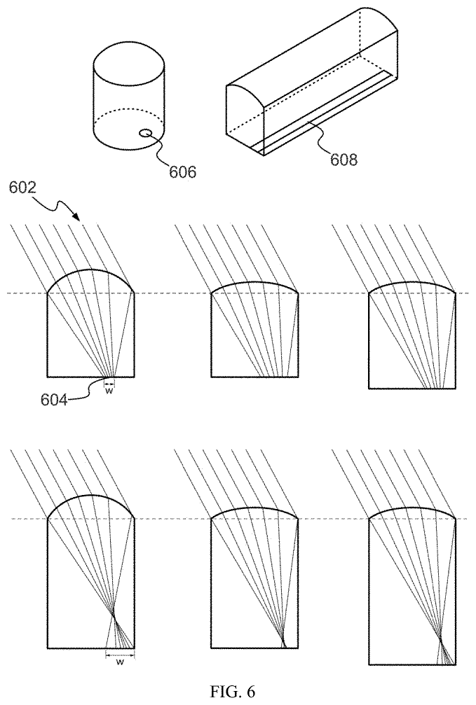

Snell's law of refraction may be applied to understand how light travels through a lens and further help to define rules for lens design. In FIG. 6, for example, when looking at a lens from a viewpoint, due to the magnifying effect of the lens, all rays 602 emerging from a viewpoint converge and reach the backplane of the lens. Thus, only a small portion of the underlying image on the backing layer can be seen from each viewpoint. The size and width (w) of this small focal window 604 that reveals partial of the underlying pattern (a patterned region) varies in different lens geometries. For example, when the cuboid thickness h₂ remains constant, a more curved lens surface may result in a smaller focal window 604 before the rays converge, and a larger focal window 604 after the rays converge. When the curvature of the lens remains constant, a deeper cuboid thickness h₂ may result in a smaller focal window before the rays converge, and a larger focal window 604 after the rays converge.

A lens with a different geometry may have a focal window 604 in various shapes and sizes. For example, a standard spherical lenticule may have a nearly circular focal window 606, while a standard cylindrical lenticule may have a stripe-shaped focal window 608.

These rules may be useful in the design of a viewpoint-dependent object. For example, designers may wish to increase the number of patterned regions available under each lens by reducing the width of each focal window 604, thereby allowing for the inclusion of more image frames to be revealed at different viewpoints. By utilizing Snell's law of refraction, it is possible to calculate the size and shape of each focal window 604 corresponding to each viewpoint and visualize the patterned region under the lens at that viewpoint.

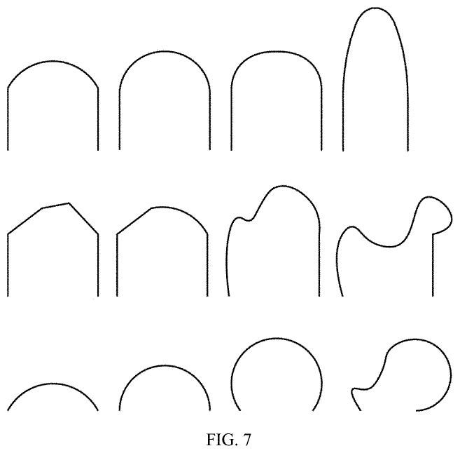

FIG. 7 illustrates a selection of exemplary section views of lens geometry design. The lens may possess various curvatures, thicknesses, sizes, shapes, and top surfaces that may be flat or curved. The contact surface between the lens and the backing layer may also take on different forms.

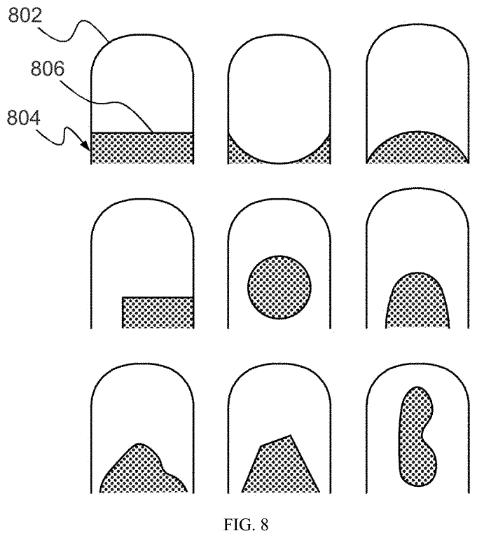

FIG. 8 displays a selection of exemplary section views of lens 802 with its backing layer 804 in different forms. The contact surfaces 806 between the lens 802 and backing layer 804 may be flat or curved. The backing layer 804 may be partially or fully enclosed within the lens. If the backing layer 804 is made from opaque materials, only the patterns on the contact surfaces 806 matters to the final lenticular effects. If the backing layer 804 is made from transparent or translucent materials that can be seen through, the volumetric information (e.g. material density, refraction index, colors of each 3D pixel) of the backing layer 804 may contribute to the final lenticular effects.

FIG. 9 presents a selection of exemplary top views of a backing layer with embedded patterns. The backing layer may contain any pattern. The contact surface of the backing layer from a standard spherical lens cell may be depicted as a circle 902 with a plurality of color pixels. The contact surface of the backing layer from a standard cylindrical lens cell may be depicted as a rectangle 904 with a plurality of color pixels. The contact surface of the backing layer from an irregularly shaped lens cell may take on any shape, such as the shape 906 depicted in the figure, and be colored with a plurality of pixels. These color pixels may further constitute patterns in various lines, colors, shapes, gradients, and fragments of text. In various embodiments, the circle 902, the rectangle 904, and the irregular shape 906 may be segmented into a plurality of portions. The segmentation may be linear, radial, or irregular. Each portion may be in various colors, gradients, and patterns. The transition between portions may be a gradual gradient.

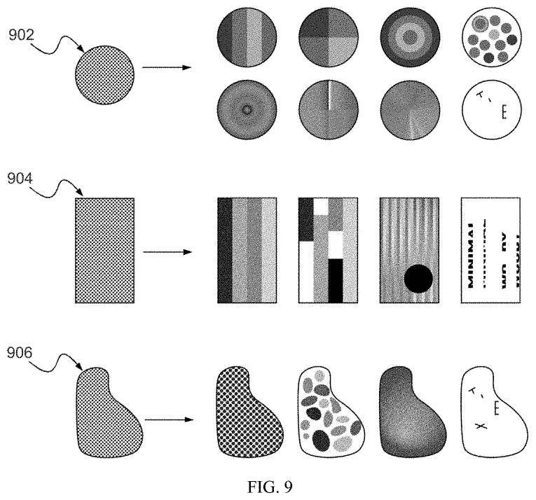

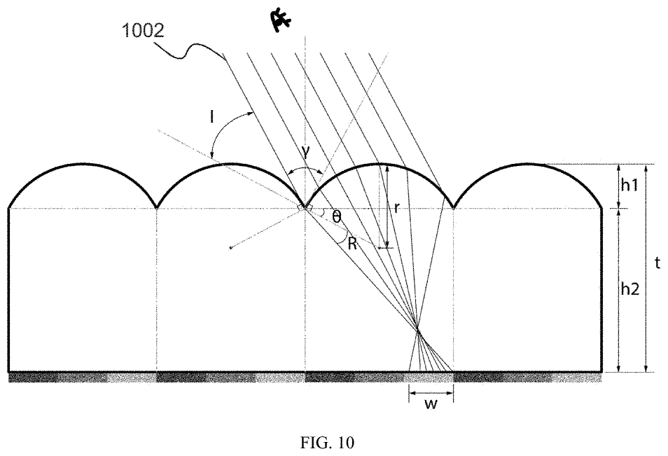

In various embodiments, designers may wish to design lenticule geometry that enables the maximum viewing angle. In order to achieve this, the lenticule geometry is designed such that the full range of the vignetting angle (γ) displays the entire image sequence (full aperture). In various embodiments, geometrically, this means the extreme ray 1002 entering from one edge of the lenticule is refracted to reach the opposite edge of the image strip, as shown in FIG. 10. Based on this theory, the system determines the relationship between the variables r, p, and t.

$$r = \frac{{p}^{2} + 4 {h}_{1}^{2}}{8 {h}_{1}}$$

$$θ = arc sin ( \frac{r - {h}_{1}}{R} )$$

$$I = 90 - 2 θ$$

$$R = arcsin ( \frac{{n}_{a i r}}{{n}_{lens material}} * sin I )$$

$$λ = θ + R$$

$${h}_{2} = p * tan λ$$

$$t = {h}_{1} + {h}_{2}$$

$$γ = 2 θ$$

Where p≤2r,
nₐᵢᵣ is the Refraction index of air
n_{lens material} is the Refraction index of lens material
R is the Refraction angle of the extreme ray
γ is the Vignetting angle

Using the above formulas, the lenticule thickness (t) can then be derived based on a given value of r and p. In various embodiments, the designed lenticular effects can be validated and applied to the final product by adjusting the parameters of the control variables.

With respect to the types of barrier-based 3D objects for multi-view displays, in various embodiments, kinetic optical illusions may be created without the use of lenses. Barrier-based 3D objects rely on images on different orientation surfaces and the movement of the base material to create color shifting effects, rather than using lens-based methods.

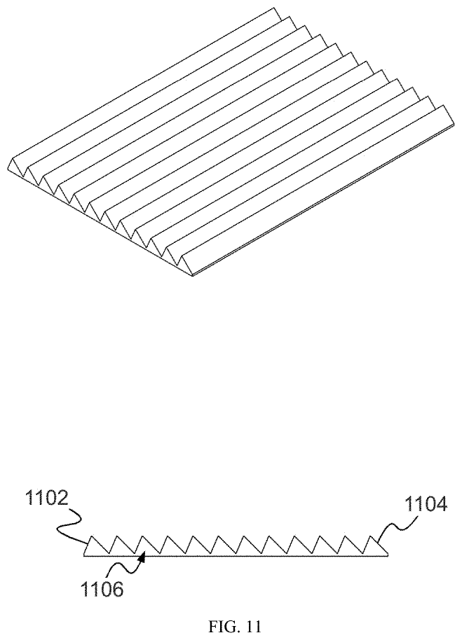

As depicted in FIG. 11, a conventional Agamograph artwork may appear as an accordion-shaped object with surfaces at two different angles, producing different images from two viewpoints. When viewed from the side of face 1102, the viewer may see an image compiled from a plurality of interlaced images facing the same side of 1102. When viewed from the side of face 1104, the viewer may see a different image compiled from a plurality of interlaced images facing the same side of 1104. The proposed system allows for the creation and production of a flat, two-sided Agamograph artwork as shown in FIG. 11. In addition, the system may allow for more than two sides in each 3D element 1106, with the angle between each pair of adjacent sides being variable, enabling the viewing of more than two images from multiple viewpoints.

The proposed system may also enable a plurality of 3D stripes to be wrapped around a three-dimensional geometry. Each 3D stripe may be in long, narrow slits with different colors or patterns assigned to each face. FIG. 12 illustrates an example of a three-dimensional geometry wrapped with a plurality of two-sided 3D stripe 1206. Patterns and colors assigned to the surfaces facing the general left side (the side surface 1202 is facing) may form an image that can only be viewed from a specific perspective on the general left side. Similarly, patterns and colors assigned to the surfaces facing the general right side (the side surface 1204 is facing) may form an image that can only be viewed from a specific perspective on the general right side. In various embodiments, the system may allow for more than two sides in each 3D stripe 1206, with the angle between each pair of adjacent sides being variable, enabling the viewing of more than two images from multiple viewpoints.

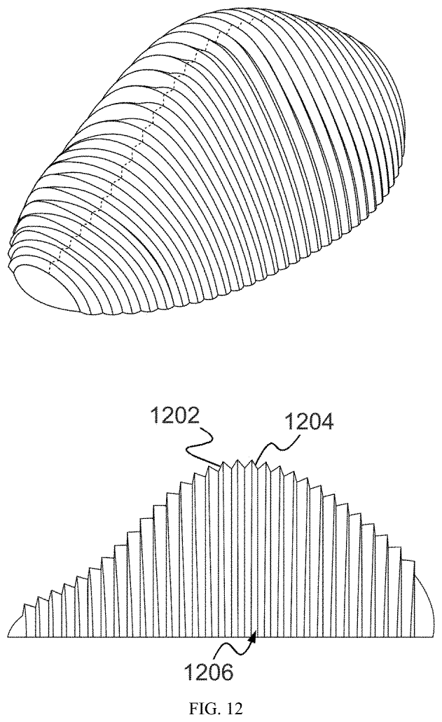

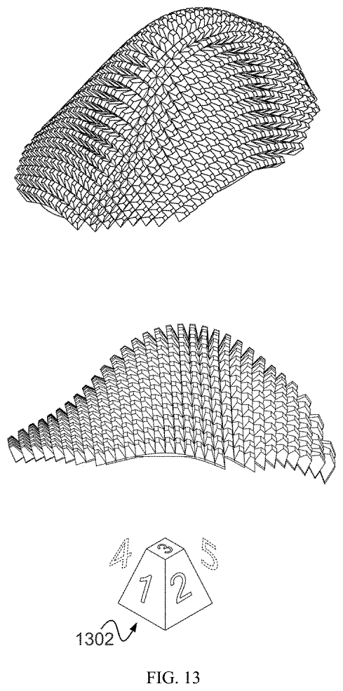

As depicted in FIG. 13, the proposed system may also enable a plurality of 3D elements to be mapped onto the surface of a 3D geometry. These elements may be convex or concave with respect to the surface of the 3D geometry and may be of any shape. Each 3D element may comprise a number of patterned faces, and the transition between these faces may be sharp or smooth. FIG. 13 illustrates an example of a 3D geometry with a plurality of five-sided frustums, such as frustum 1302. Each frustum may have a slightly different form to be mapped onto the surface of the 3D geometry. Patterns and colors may be assigned to the faces of the frustum. When viewed from different angles, the appearance of the three-dimensional geometry may change dynamically.

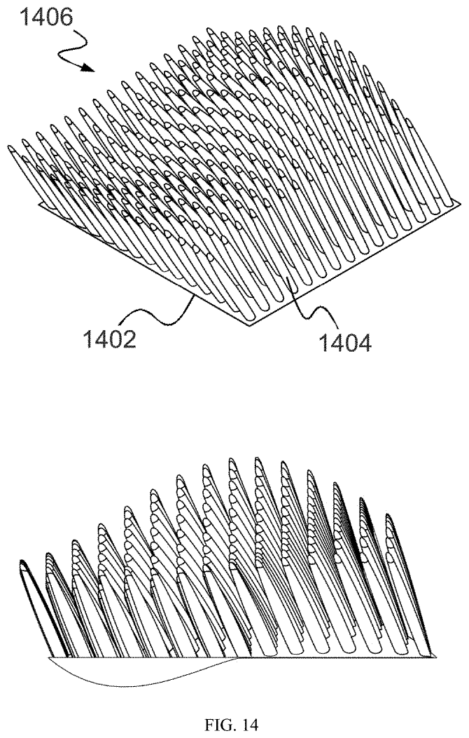

As set forth in FIG. 14, in various embodiments, a fabric 1402 may have a plurality of 3D fibers 1404 applied to its surface to create a textile 1406. The disclosure enables designers to program the size and spatial density of the fibers, which affects the drape of the fabric. Areas with smaller, fur-like fibers may appear more flexible and visually dynamic due to their higher density, while areas with larger and shorter fibers may appear more rigid and visually calm due to their lower density. The fibers may also be given colors, gradients, and patterns on their surface. When viewed from different angles, the appearance of the textile may change dynamically. When the fabric drapes, different colors may be revealed dynamically. In various embodiments, the textile 1406 may be further made into clothing, garments, accessories, and other items to display a unique visual dynamism when the fabric drapes.

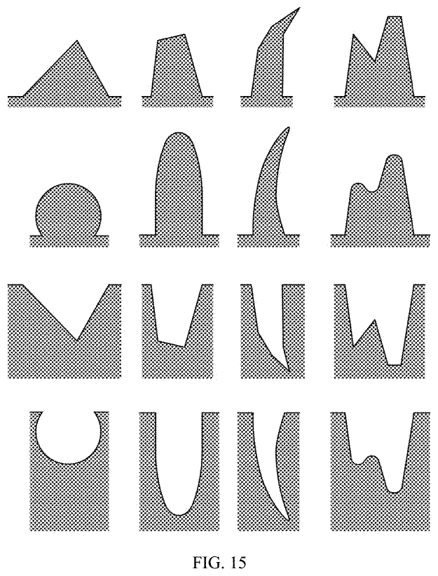

With respect to structures and rules of barrier-based 3D objects for multi-view displays, in various embodiments, FIG. 15 illustrates a selection of exemplary section views of 3D element geometry designs. As shown, the 3D element may be concave or convex with respect to an object surface. Additionally, the 3D element may have a plurality of surfaces facing various orientations. These surfaces may be curved or flat, and the transition between them may be sharp or smooth.

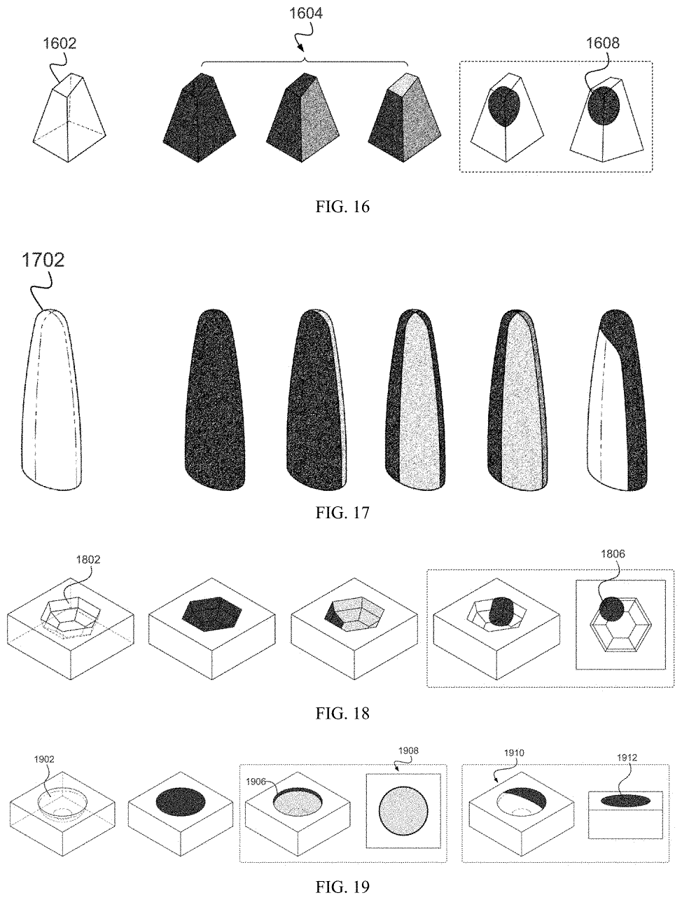

3D elements on a 3D object may take various patterns and shapes. FIG. 16 includes an exemplary positive multi-faced 3D element 1602 to illustrate the general rules and methods of color assignment on the surfaces of a 3D element. The 3D element may have all its surfaces in the same color/pattern, or multiple surfaces using one color/pattern, or all surfaces in different colors/patterns, as shown in the three options 1604 of the 3D elements 1602. Additionally, the proposed system may project a pattern or partial of a pattern onto the surface(s) of the 3D element 1602. When viewed from the angle where the pattern (in this case, an ellipse) was projected from, the viewer can see the full, original pattern without distortion (in this case, a perfect and continuous ellipse 1608).

FIG. 17 includes an exemplary positive 3D element 1702 with smooth surfaces. While this element may not have apparent parting lines between its surfaces, the proposed system may still segment the surfaces using features such as curvature lines, UV lines, meshes, or a projected outline from a pattern at a perspective angle. Different colors and patterns may then be assigned to the segmented surfaces of the 3D element.

FIG. 18 includes an exemplary negative multi-faced 3D element 1802. This element may have all its surfaces in the same color/pattern, or multiple surfaces using a single color/pattern. In various embodiments, all or some surfaces may be in different colors/patterns. The proposed system may also project a pattern or partial of a pattern onto the surface(s) of the 3D element. When viewed from the angle where the pattern (in this case, a circle) was projected from, the viewer can see the full, original pattern without distortion (in this case, a perfect and continuous circle 1806).

FIG. 19 includes an exemplary negative 3D element 1902 with smooth surfaces. Similar to the methods described above, the proposed system can segment the surfaces and assign different colors and patterns to the segmented surfaces of the 3D element. In various embodiments, the 3D element 1902 may be designed in a way that certain patterns are mostly or completely hidden from a specific perspective and revealed from other perspectives. For example, as shown in the top view 1908 of the 3D element 1902, the color strip 1906 near the edge of the 3D element 1902 is barely visible when viewed from the top. Additionally, the 3D element may be designed to have a designated color/pattern fill the fully exposed surface of the cavity at a certain perspective, such as show in view 1912, while appearing in different colors/patterns when viewed from other perspectives, as depicted in the view 1910.

By following the basic rules outlined in the system, a wide range of optical illusions and visually dynamic 3D objects can be generated. Such as allowing an image to be revealed only at certain viewpoints and produces color shifting effects when viewpoints are changed. The system also allows for the creation of visually dynamic 3D objects by combining a plurality of 3D elements in various shapes, sizes, colors, gradients, patterns, and flexibilities.

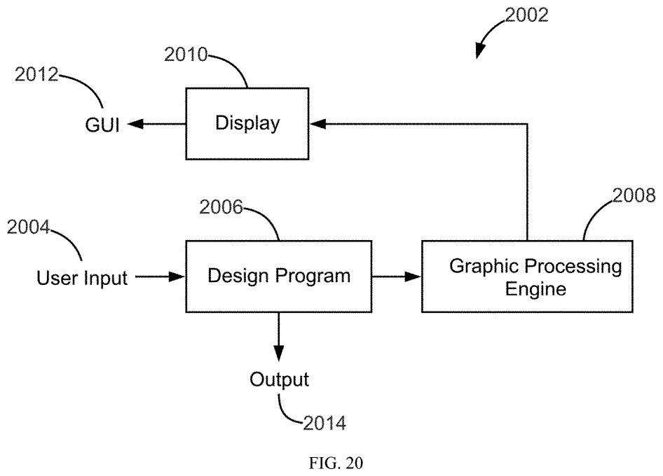

With respect to a computer system to create a digital model of a 3D object for multi-view displays, the design of a 3D object for multi-view displays may involve using a computer system. FIG. 20 shows a block diagram of an exemplary computer system 2002. The computer system 2002 includes a design program 2006 where computer code and data may reside. The design program 2006 may contain various components such as a 3D modeling software, a virtual camera representing viewing locations to look at an object, a shape generation tool, a rendering software with ray tracing capability, an image uploading/editing tool, and a model appearance and material editing tool.

The design of a 3D object with optical illusion may include certain user inputs 2004 to be provided to the design program 2006. These user inputs 2004 may include a set of parameters or attributes, or files, that help the system define the geometry, surface patterns, material properties, etc. of the object based on the rules and examples discussed above, such as in FIGS. 5-10 and 15-19. The design program 2006 may include geometry or pattern templates and a library for the user to choose from. The design program 2006 is configured to execute instructions from the user input 2004 and to pass data to a graphic processing engine 2008. For example, the user may place an object in a 3D design space and provide an input 2004 with attributes such as the location of the viewpoints, sizes, materials, colors, patterns, etc. of the object. The design program 2006 then determines the visual effects to be applied to the 3D object.

The graphic processing engine 2008 receives data from the design software 2006 and combines the data into a stream. This data stream is then transmitted to a processing unit, such as a GPU, which processes the data and sends the results to a display 2010. The display 2010 is configured to display a graphical user interface (GUI) 2012, which serves as an interface between a user and the operating system or applications running behind. The GUI 2012 may comprise various graphical elements such as cursors, buttons, menus, windows, and design spaces/views, etc. These graphical elements may also include a visualization of the current design choices created by specific actions taken by the user. The user may view the design from different angles using a 3D view in the design space. Once the design is finalized by the user, the design program 2006 may generate an output file 2014 that can be viewed, printed, rendered, or processed by other software.

In various embodiments, the design program 2006 may be capable of volumetric modeling and is optimized for voxel printing. Unlike traditional CAD tools, which can only create a hollow shell of geometry, the design program 2006 with volumetric modeling capability allows the user to create the interior of a geometry and specify the properties of each individual voxel (3D pixel) throughout the entire volume of the model. For example, the user may define a color and material property for each voxel. The models generated by the proposed system may be full of material information that can be transmitted to a 3D printer for printing.

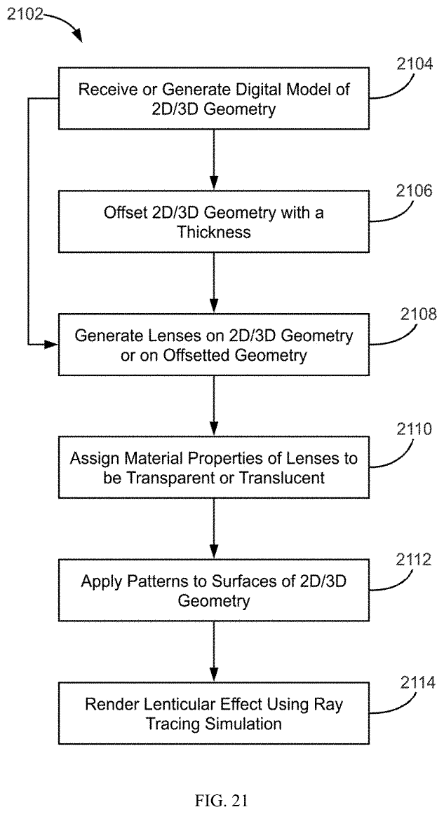

With respect to designing and creating lens-based 3D objects for multi-view displays, FIG. 21 is a workflow 2102 for designing and creating a lens-based 3D object for multi-view displays in accordance with various embodiments. The workflow 2102 may be performed using the system shown in FIG. 20 and may begin at block 2104 with the creation or receipt of a digital model of a 2D or 3D geometry. From block 2104, the workflow 2102 proceeds to block 2106, where the geometry is offset with a thickness. This step is particularly useful for creating lenticular objects with long and narrow lenses, such as those shown in FIGS. 1 and 2. After block 2106, the workflow 2102 moves on to block 2108, where lenses are generated and mapped onto the offsetted geometry. In various embodiments, block 2108 may be performed by a user inputting specific parameters related to the geometry of the lenses. In other embodiments, block 2108 may be accomplished through the automatic generation of lenses based on user-specified effects and a loaded base geometry. In some scenarios, block 2106 may be skipped, and the workflow 2102 may proceed directly from block 2104 to block 2108, where lenses are generated and mapped onto the original geometry. Following block 2108, the workflow 2102 proceeds to block 2110, where the lenses are defined with material properties, typically transparent or translucent materials. The workflow then moves on to block 2112, where patterns or colors are applied to the surfaces of the original geometry. In various embodiments, block 2112 is followed by block 2114, where the lenticular effects are rendered using ray tracing simulation and displayed in GUI.

The disclosure includes the mapping of two broad types of lenses onto 3D surfaces. The first type of lens is an elongated lens, such as a lenticular lens, which is typically long and narrow and arranged in an array. The second type of lens is an integral lens, such as a fly's eye lens, which is typically a dotted lens dispersed over a surface. The disclosure further includes the design of lens-based 3D objects using different lens distribution methods. The workflow described below may utilize any of the 3D element geometries introduced in previous sections, including but not limited to the 3D element geometries depicted in FIG. 7-9.

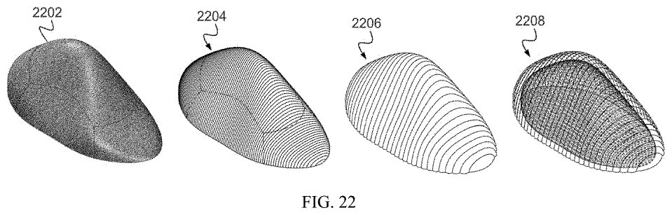

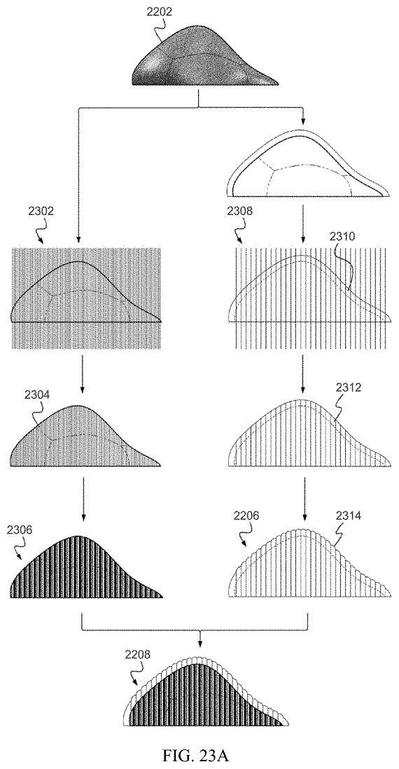

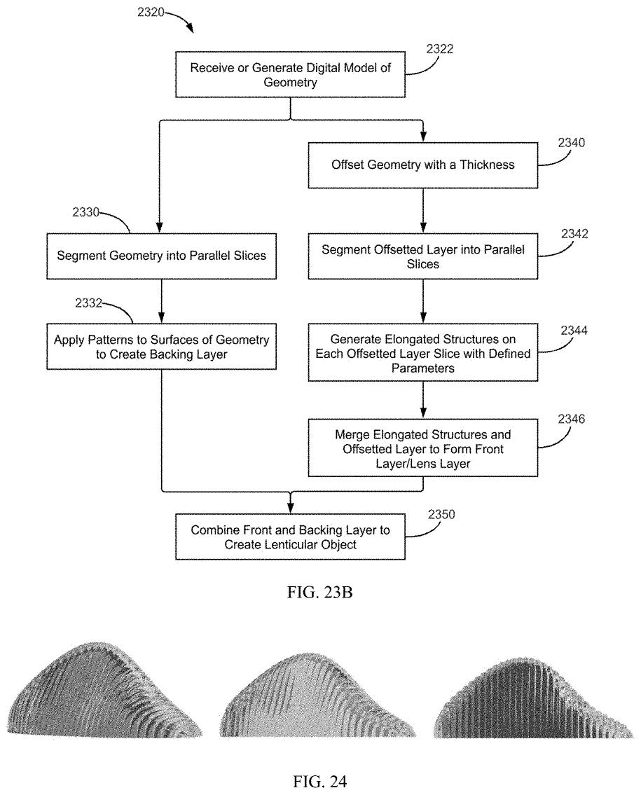

With respect to the design with elongated lenses, in various embodiments, the system may create lenticular 3D objects with long and narrow lens arrays or with lens in line distributions. In various embodiments, a 3D lenticular object may have lenses arranged in parallel to each other. FIGS. 22, 23A, and 23B show the general structure and design process 2320 for an exemplary 3D lenticular object 2208 with a parallel lens distribution. The design process may begin with the creation or receipt of a digital model of a geometry 2202 (block 2322). The process continues to creating a backing layer 2306 with image content (block 2330 and 2332). This involves segmenting the original geometry 2202 into a segmented geometry 2204 with a plurality of parallel slices 2304 (block 2330). Patterns are then applied to the surfaces of the geometry 2202 (block 2332). The system also creates a front layer with lenses as follows (block 2340 to 2346). This process begins by offsetting the original geometry 2202 with a defined thickness (block 2340) and segmenting the offsetted layer 2310 into a plurality of parallel slices (block 2342). Elongated structures 2314 are generated on each slice 2312 of the offsetted layer (block 2344) using defined parameters. The elongated structures and offsetted layer are then merged to form the front layer 2206 (block 2346). The front layer 2206 is combined with the backing layer 2306 to create the 3D lenticular object 2208 (block 2350). The resulting 3D lenticular object 2208 may display completely different colors and patterns in different viewpoints, as shown in FIG. 24.

In various embodiments, the original geometry and offsetted geometry may be segmented by using a set of paralleled cutting planes, such as cutting planes 2302 and 2308. The gap between these cutting planes may be constant or varied as desired.

In various embodiments, the front layer 2206 may include n slices, and the backing layer 2306 may include n*m slices in order to create an optimal optical effect for viewing multiple underlying images (where m represents the number of embedded images).

In various embodiments, generating elongated structures 2314 on each offsetted layer slice 2312 may be performed using tools and features such as “surface loft”.

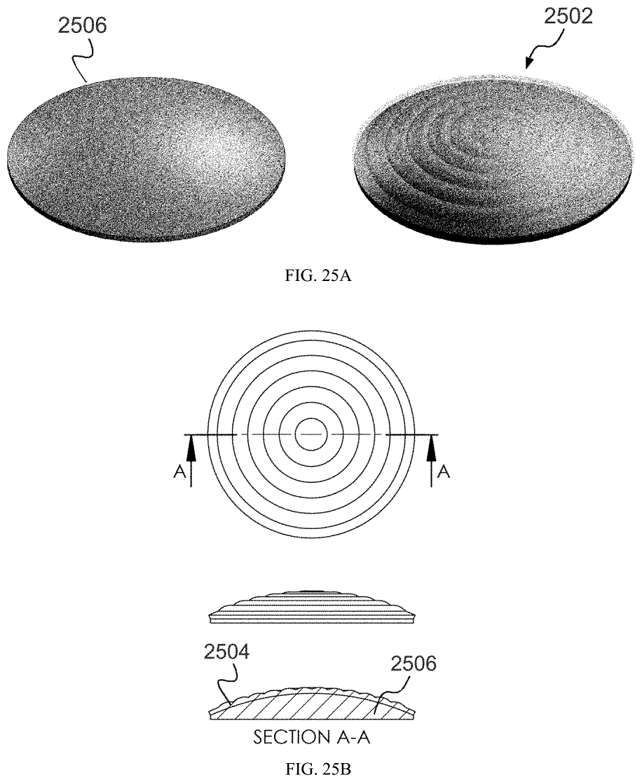

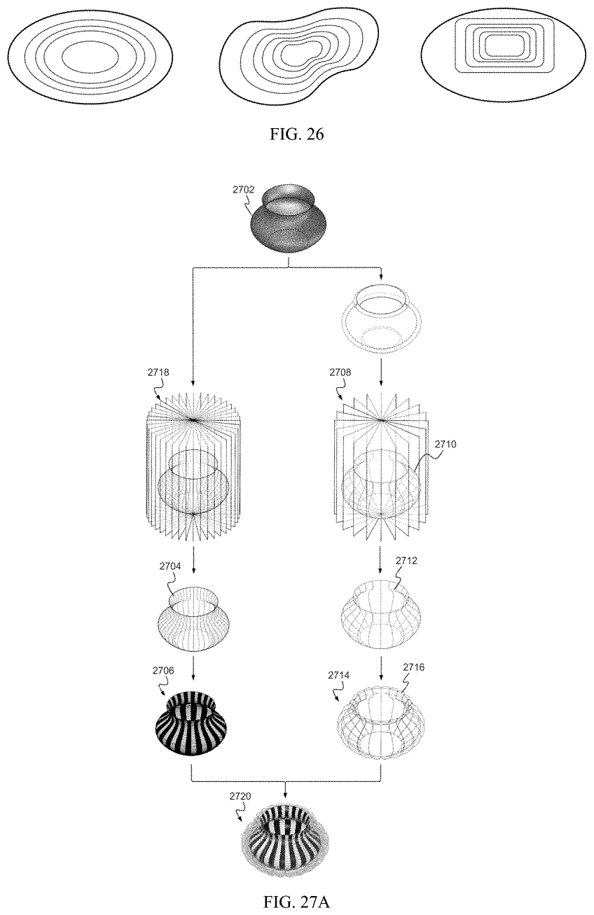

In various embodiments, a 3D lenticular object may have lenses arranged in a spiral or concentric configuration. FIGS. 25A and 25B illustrate an exemplary 3D lenticular object 2502 with a ring-shaped lens distribution. As depicted in FIG. 25B, the front layer 2504 may follow the curvature of a base geometry 2506 and map the lens distribution accordingly. A similar concentric lens distribution may be used with asymmetric geometry, with the width of each lens being constant or varied as desired (as shown in FIG. 26).

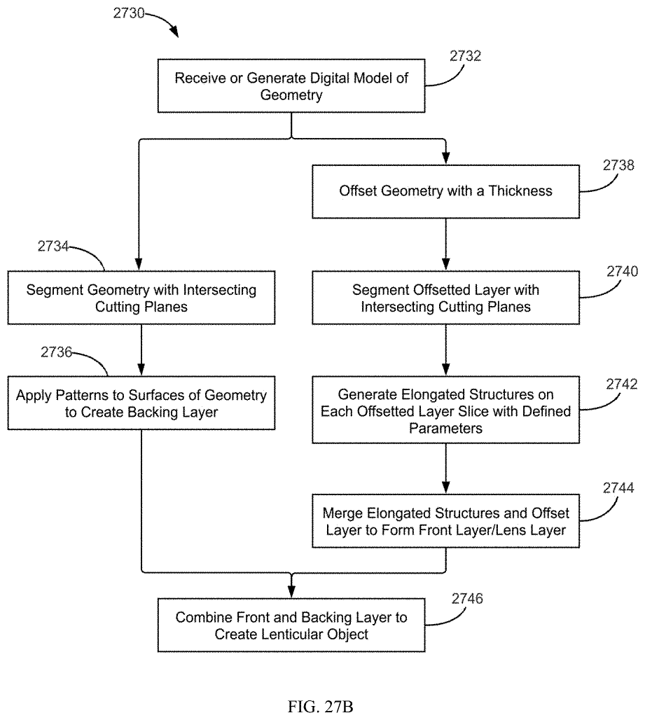

In various embodiments, a 3D lenticular object may have backing layer split with intersecting cutting planes, such as cutting planes distributed in circular or curve driven patterns instead of linear patterns. FIGS. 27A and 27B show the general design process 2730 for an exemplary 3D lenticular object 2720 with a circular pattern lens distribution. The design process 2730 may begin with the creation or receipt of a digital model of a geometry 2702 (block 2732). The process continues to creating a backing layer 2706 with image content (block 2734 and 2736). This involves segmenting the original geometry 2702 with a plurality of intersecting cutting planes 2718 to get a plurality of sections 2704 (block 2734). Patterns are then applied to the surfaces of the geometry 2702 (block 2736). The system also creates a front layer with lenses as follows (block 2837 to 2744). This process begins by offsetting the original geometry 2702 with a defined thickness (block 2738) and segmenting the offsetted layer 2710 into a plurality of sections (block 2740). Elongated structures 2716 are generated on each slice 2712 of the offsetted layer (block 2742) using defined parameters. The elongated structures and offsetted layer are then merged to form a front layer 2714 (block 2744). The front layer 2714 is combined with the backing layer 2706 to create the 3D lenticular object 2720 (block 2746).

In various embodiments, the intersecting cutting planes may intersect in one single line or multiple lines. The gap between these cutting planes may be constant or varied as desired.

In various embodiments, the front layer 2714 may include n slices, and the backing layer 2706 may include n*m slices in order to create an optimal optical effect for viewing multiple underlying images (where m represents the number of embedded images).

In various embodiments, generating elongated structures 2716 on each offsetted layer slice 2712 may be performed using tools and features such as “2-rail sweeping loft”.

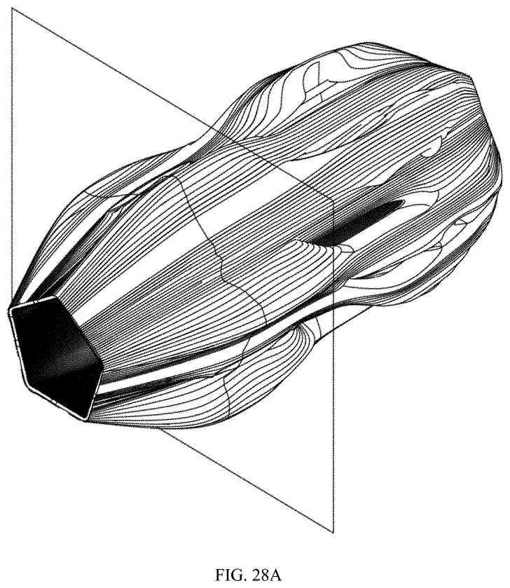

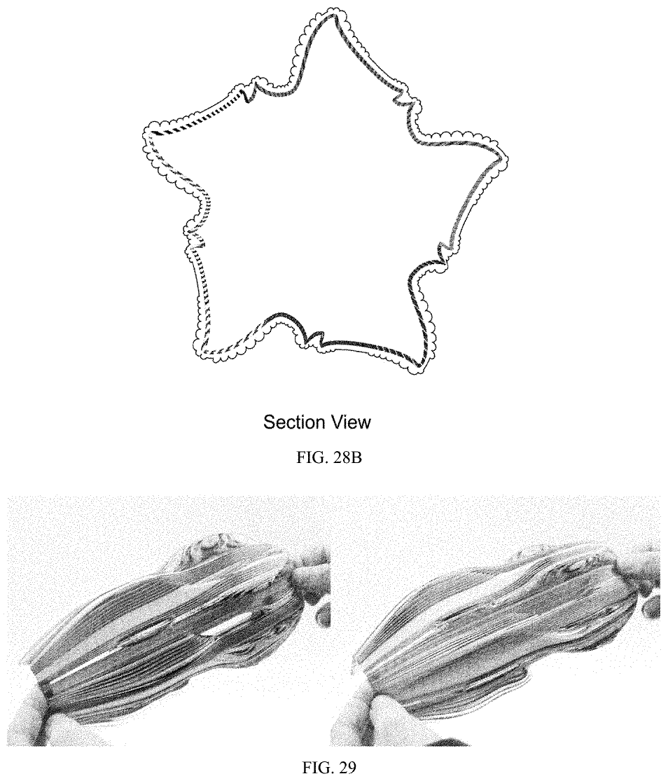

A digital model of an even more complex lenticular object, as shown in FIGS. 28A and 28B, can be created using workflow 2730 and further 3D printed. The resulting lenticular object exhibits a dynamic display surface that appears to change colors when rotated, as shown in FIG. 29.

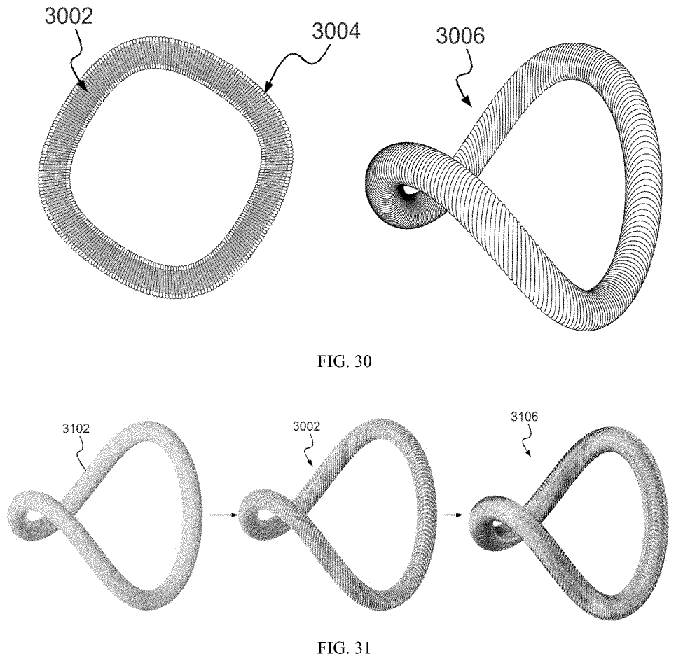

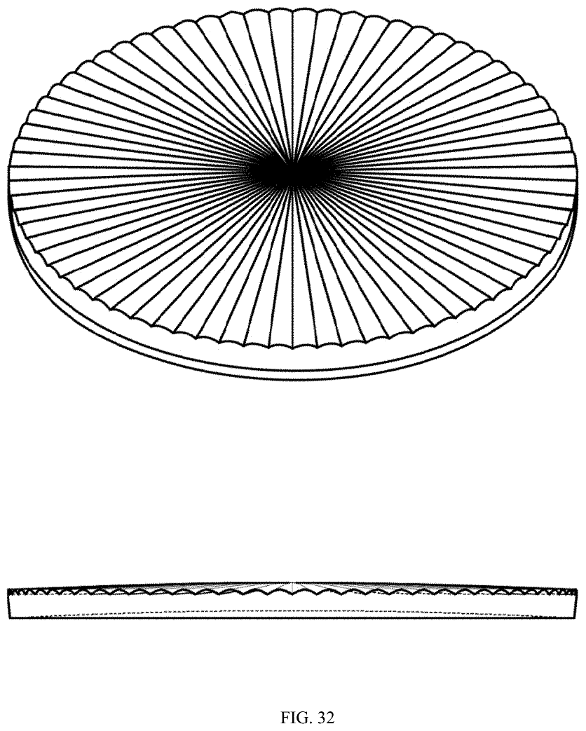

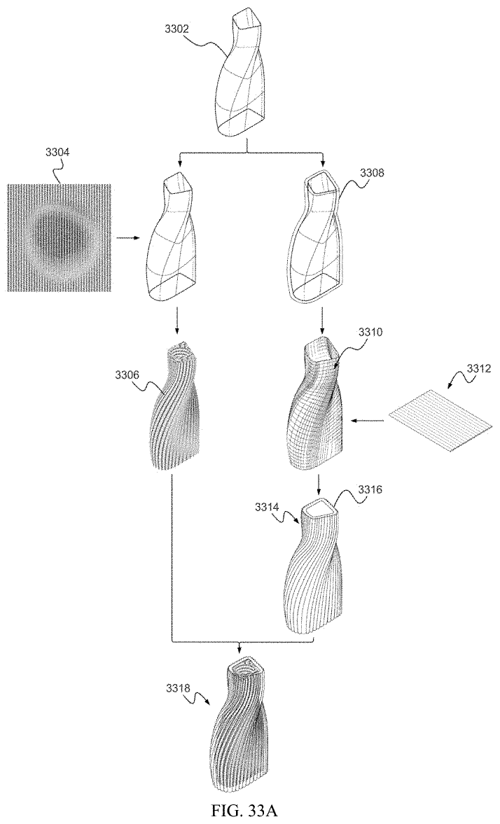

In various embodiments, design workflow 2730 may apply to a sweep object (object created by taking a closed section profile and moving it along a defined path curve). As shown in FIGS. 30 and 31, a loop-like geometry 3102 is first segmented into a number of grouped colored sections, forming a backing layer 3002. A front layer 3004 with lenses is then generated on top of the backing layer, resulting in a 3D lenticular object 3006. As shown in the rendered view 3106 of the 3D lenticular object 3006, the color transition becomes smooth with the addition of the lens layer.

In various embodiments, design workflow 2730 may be applied on a spread surface rather than around a hollow geometry, as depicted in FIG. 32.

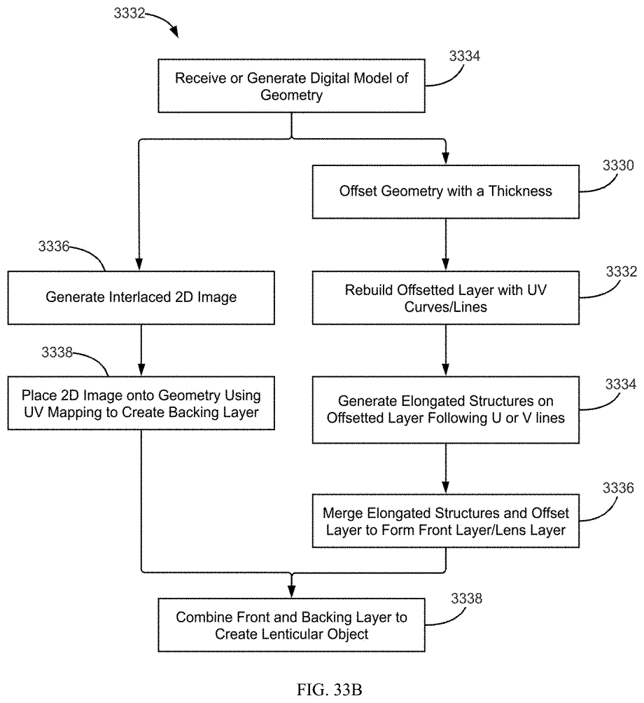

In various embodiments, a 3D lenticular object may have lenses and textures that are mapped to follow surface curvatures, such as UV curves. The design process 3332 for an exemplary 3D lenticular object 3318 with UV mapped lenses is shown in FIGS. 33A and 33B. The design process 3332 for may begin by creating or receiving a digital model of the object's geometry 3302 (block 3334). The process may then proceed to the creation of a backing layer 3306 with image content (blocks 3336 and 3338). This may involve generating an interlaced 2D image 3304 (block 3336) and applying it to the geometry 3302 using UV mapping (block 3338). The system also creates a front layer 3314 with lenses as follows (block 3330 to 3336). This process may begin by offsetting the original geometry 3302 with a defined thickness (block 3330) and extracting a number of UV curves/lines 3310 on the offsetted geometry 3308, this step may involve rebuilding the offsetted geometry 3308 (block 3332). Elongated structures 3316 are generated on the geometry 3308 following the extracted U or V lines (block 3334). This step may be performed by building a flat array 3312 of lenticular lenses and wrapping the lens array 3312 onto the offsetted geometry 3308 using features/tools like “flow along surface”. The elongated structures and offsetted layer are then merged to form a front layer 3314 (block 3336). The front layer 3314 is combined with the backing layer 3306 to create the 3D lenticular object 3318 (block 3338). The steps of the method may be performed in the order described, or in a different order.

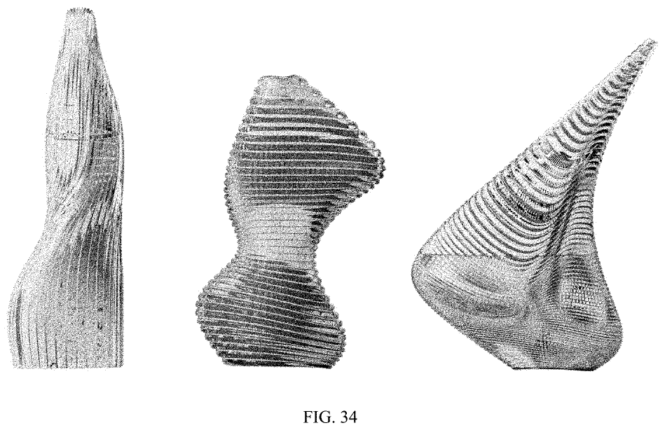

In various embodiments, FIG. 34 shows the rendering of three lenticular objects designed with the process 3332. In various embodiments, the front layer and backing layer can be specifically designed to display multiple embedded images effectively. The front layer may include n lenticules, while the backing layer may include n*m pattern slices, where m represents the number of embedded image frames. In a method of operation, the backing layer may be rebuilt with n*m*i V or U lines, where i is any positive integer, in the process of rebuilding the offsetted layer with UV lines. The system may also include a flat lens array having n lenticules. The number of laces and lace width in a 2D image may be determined based on the designed image groups. In the step of mapping a 2D image with UV coordinates, small adjustments to the positioning of textures may be made.

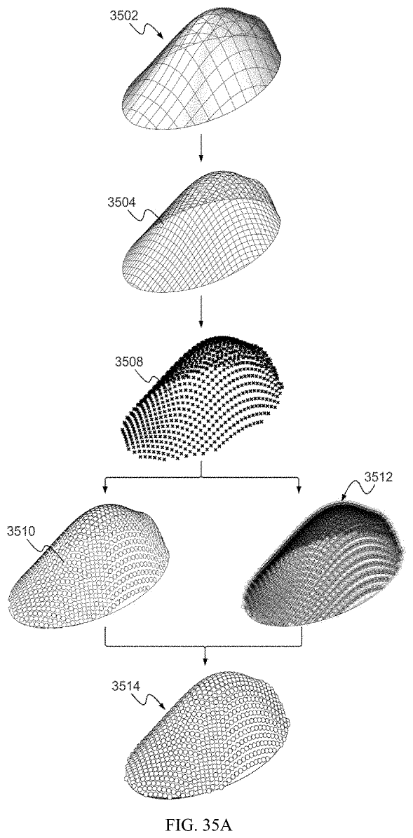

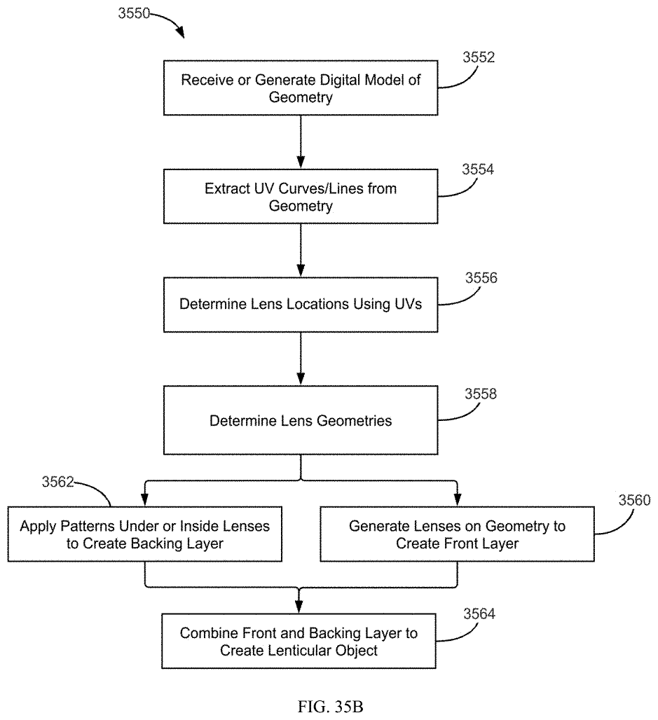

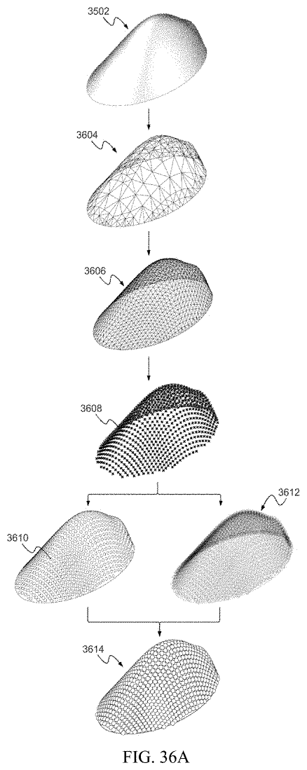

With respect to design with integral lenses, in various embodiments, the system may include creating designs of lens-covered 3D objects with lenses arranged in a grid, lens-covered 3D objects with dotted lenses dispersed over a surface, lens-covered 3D objects with standalone lenses, lens-covered 3D objects with scattered or clustered lenses, and/or lenticular 3D objects with lens in dot distributions. In various embodiments, a 3D object may have standalone lenses dispersed over the surface. FIGS. 35A and 35B show a UV-based design process 3550 for an exemplary 3D object 3514 with dotted lenses arranged in a grid. The design process may begin by creating or receiving a digital model of a geometry 3502 in NURBS format or converting the model into NURBS (block 3552). The process may then involve extracting a plurality of UV lines 3504 from the geometry 3502 (block 3554). The locations of the lenses may be determined using the UV lines 3504 and, in various embodiments, by identifying the center of each lens 3508 at each intersecting point of UV lines (block 3556). The system may then determine a lens geometry with a set of parameters (block 3558) and generate the lenses 3512 on the geometry 3502 using the defined lens center and geometry. The system may also define an image region 3510 under or inside each lens and apply colors or patterns to each image region (block 3562). The lens layer is combined with the backing layer to create the 3D lens-covered object 3514 (block 3564).

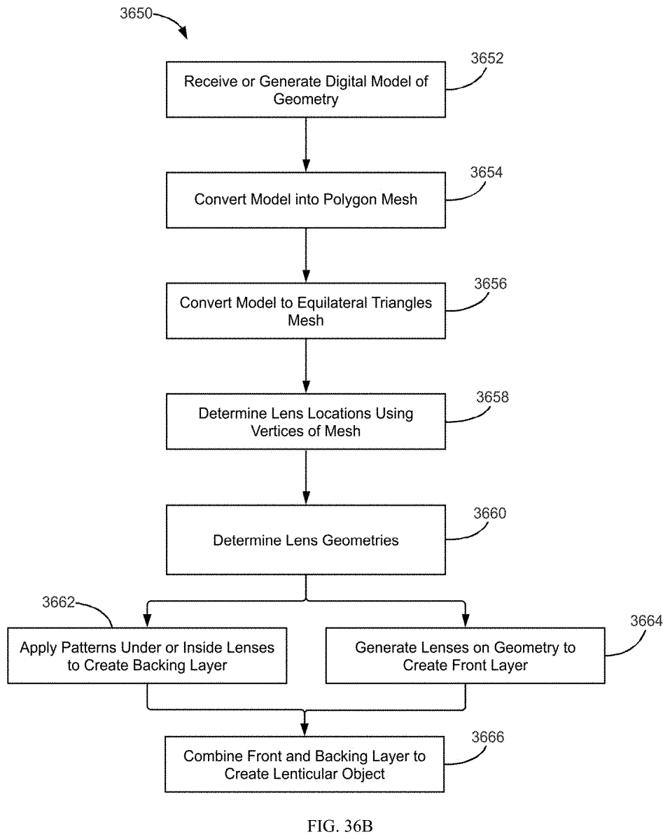

FIGS. 36A and 36B show a mesh triangulation-based design process 3650 for an exemplary 3D object 3502 with dotted lenses arranged in a grid. This process normally results in a denser lens distribution, maximizing image resolution of the lenticular display. The design process may begin by creating or receiving a digital model of a geometry 3502 (block 3552). The process may then involve converting the 3D model 3502 into a polygon mesh 3604 with a plurality of vertices, edges and faces (block 3654) and, in various embodiments, by further converting the model to an equilateral triangles mesh 3606 (block 3656). The center of the lenses 3608 may be determined using each of the plurality of vertices (block 3658). The system may then determine a lens geometry with a set of parameters (block 3660) and generate the lenses 3612 on the geometry 3502 using the defined lens center and geometry (block 3664). The system may also define an image region 3610 under or inside each lens and apply colors or patterns to each image region (block 3662). The lens layer is combined with the backing layer to create the 3D lens-covered object 3614 (block 3666).

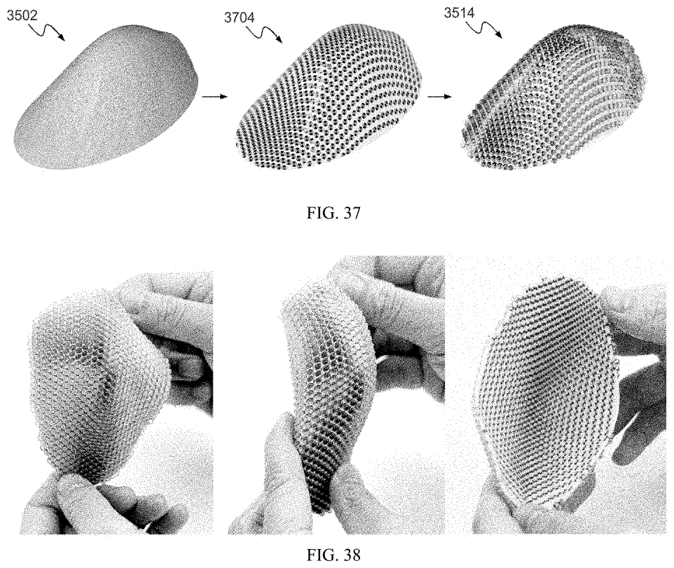

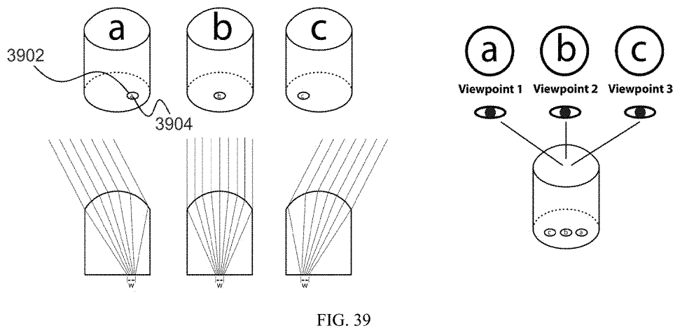

FIG. 37 shows the rendering of the original base geometry 3502, the backing layer 3704 with patterned regions and the final lens-based 3D object 3510. In various embodiments, the lens-based object 3514 may be produced using flexible materials as shown in FIG. 38. The optical effects on the object changes with user's interactions.

With respect to design viewpoint-dependent lens-covered object, in various embodiments, designers may wish to precisely define a plurality of images to be revealed at desired viewpoints. This can be achieved by applying basic rules in ray tracing and light refractions. As set forth in FIG. 39, only a small portion of the underlying image on the backing layer can be seen from each viewpoint. The shape, size and location of this small focal window 3902 that reveals partial of the underlying pattern (a patterned region 3904) depend on lens geometry and viewpoint location. If the image regions under 3 focal windows from 3 viewpoints are patterned with a, b, c, viewer sees the lens reveal pattern a, b, c at these 3 viewpoints.

In various embodiments, it is desired to specify the display of a set of images at specific viewpoints. This can be accomplished through the application of fundamental principles of ray tracing and light refraction. As illustrated in FIG. 39, only a limited portion of the underlying image on the backing layer is visible from any given viewpoint. The shape, size, and position of this small focal window 3902 that reveals a part of the underlying pattern (a patterned region 3904) depend on the lens geometry, properties and the location of the viewpoint. If the image regions beneath the focal windows at three different viewpoints are patterned with a, b, and c, the viewer will see the lens display pattern a at viewpoint 1, display pattern b at viewpoint 2, and display pattern c at viewpoint 3.

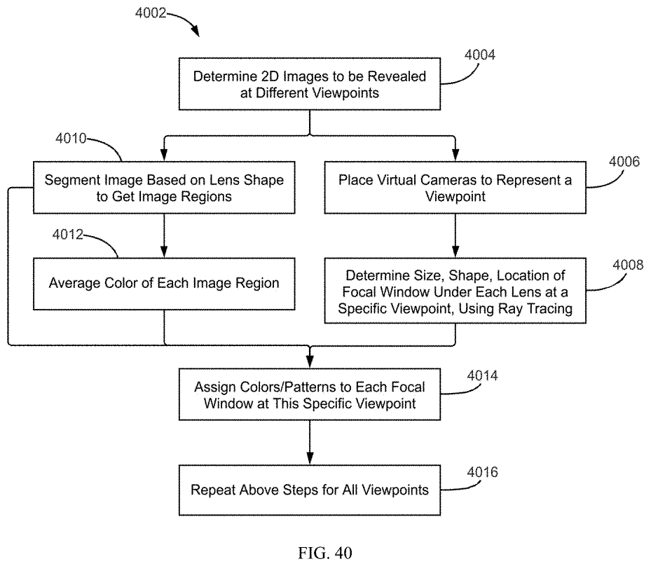

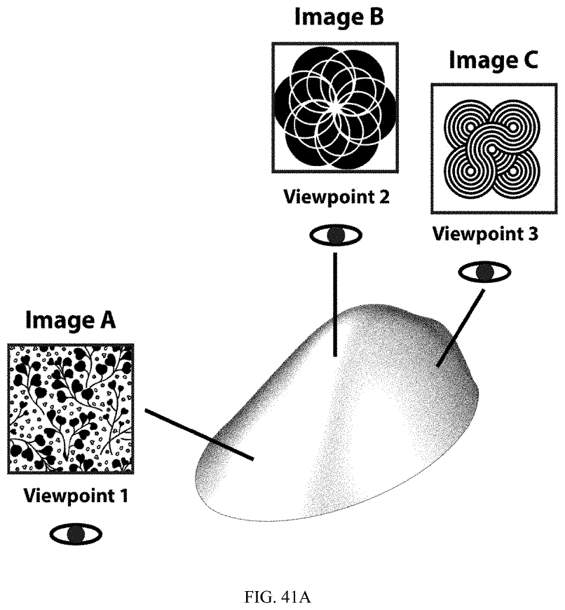

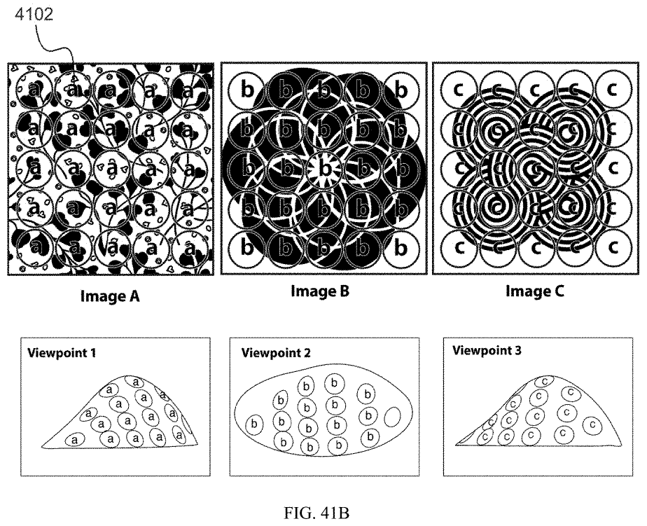

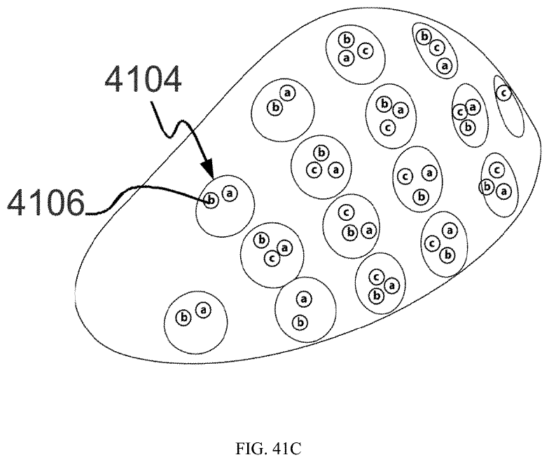

In various embodiments, the overall workflow for creating a lens object with viewpoint-dependent display may involve one or more of the steps outlined in FIG. 40. The workflow 4002 may begin at block 4004 by identifying a set of 2D images to be displayed at a predetermined set of viewpoints. FIGS. 41A, 41B, and 41C illustrate this process using an example of a lens-covered object that reveals three images (Image A, Image B, and Image C) at three viewpoints (Viewpoint 1, Viewpoint 2, Viewpoint 3). After block 4004, the system may proceed to block 4010, where it segments a 2D image into a plurality of image regions 4102, the shape of image region 4102 may follow the defined lens shapes or can be other shapes. Optionally, the system may then average the colors within each image region 4102 at block 4012, so that each image region becomes a single-color pixel. The system may place virtual cameras at the predetermined viewpoints (block 4006), such as shown in FIG. 41B: at Viewpoint 1, all lenses are intended to display image regions from Image A; at Viewpoint 2, all lenses are intended to display image regions from Image B; at Viewpoint 3, all lenses are intended to display image regions from Image C. Using this viewpoint and lens property information, the system may determine the size, shape, and location of the focal windows under each lens at a specific viewpoint through ray tracing (block 4008). The system then assigns colors or patterns, or averaged colors, to each focal window at this specific viewpoint, this may be done by UV mapping technique (block 4014). These steps may be repeated to assign colors to all focal windows at the different viewpoints (block 4016). The resulting backing layer of the lens-covered object may resemble FIG. 41C, where each lens area 4104 may comprise multiple corresponding patterned regions 4106 whose patterns are derived from Images A, B, and C.

In various embodiments, an image region from the 2D image may be further divided into a number of smaller image sectors. At each viewpoint, each lens may display an image sector rather than an image region. In this case, the resolution of the lens, or the lenticular display resolution, does not need to be the same as the resolution of the segmented image.

With respect to designing and creating barrier-based 3D objects for multi-view displays, like lens-based objects, there are also two broad types of 3D elements on barrier-based 3D objects for multi-view displays. The first type is an elongated 3D strip, which is typically long and narrow and arranged in an array. The second type is a standalone 3D element dispersed over a surface. The disclosure further includes the design of barrier-based 3D objects using different 3D element distribution methods. The workflow described below may utilize any of the 3D element geometries introduced in previous sections, including but not limited to the 3D element geometries depicted in FIG. 15-19.

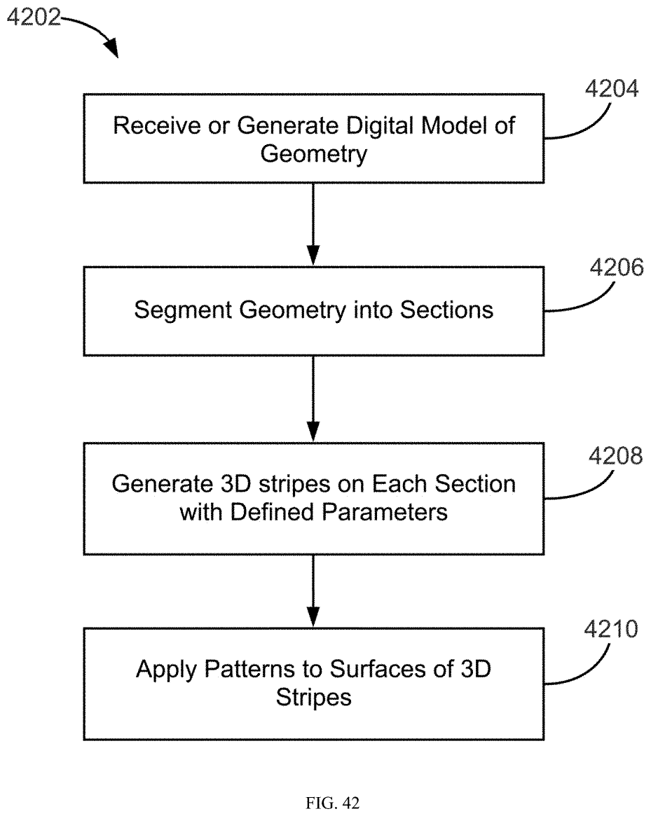

With respect to designing with 3D elongated stripes, in various embodiments, the process of creating a barrier-based object with 3D elongated stripes may involve one or more steps as outlined in FIG. 42. The workflow may commence with the creation or acquisition of a digital model of a geometry (block 4204). The process may then proceed to the segmentation of the geometry into sections (block 4206). Subsequently, the system may generate 3D elongated stripes on the surface of the geometry, with the shapes of the stripes being determined by a set of parameters, and with the distribution following segmented section geometry (block 4208). The system may then apply patterns or images to the surfaces of the 3D stripes (block 4210).

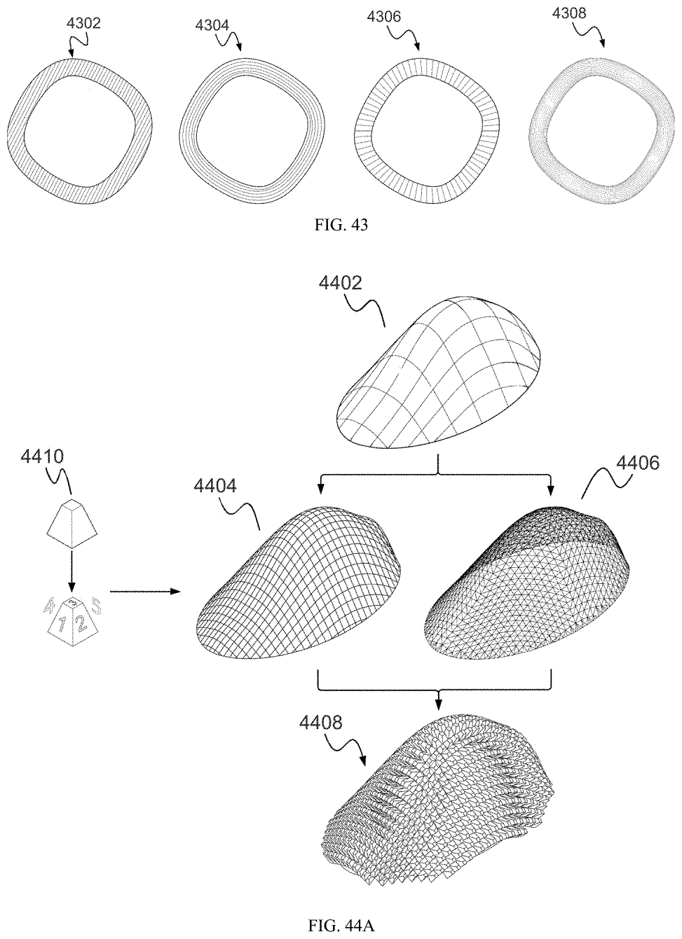

As set forth in FIG. 43, in various embodiment, the geometry may be segmented into sections in a variety of ways, including parallel distributions 4302, spiral or concentric configurations 4304, or intersecting cutting planes 4306 that may intersect in one single line or multiple lines, with the gap between the planes being constant or varied. In another embodiment, the segmentation may follow surface curvatures, such as UV curves 4308. These methods of segmentation are not exhaustive and other configurations may be used.

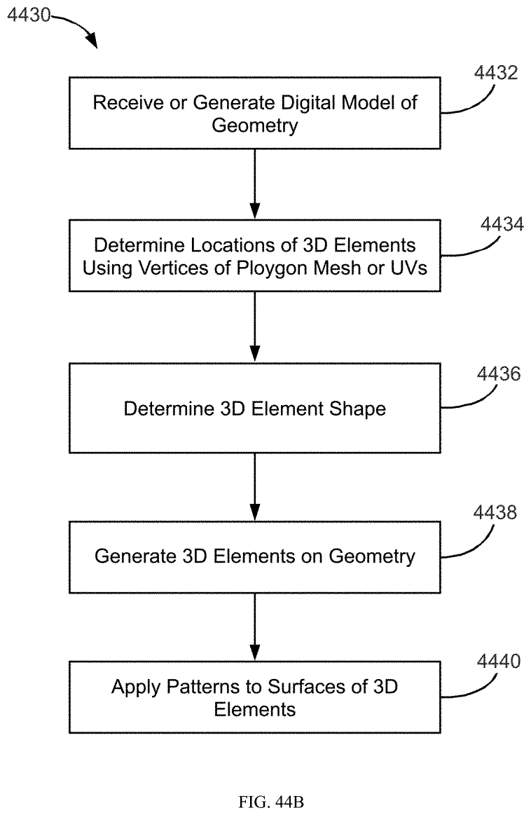

With respect to designing with standalone 3D elements, in various embodiments, a barrier-based 3D object may have standalone 3D elements dispersed over the surface. The process of creating an exemplary barrier-based object 4408 with standalone 3D elements may involve one or more steps as outlined in FIGS. 44A and 44B.

The design process 4430 may begin by creating or receiving a digital model of a geometry 4402 (block 4432). The process may proceed to block 4434, which involve converting the geometry into a polygon mesh 4406 with a plurality of vertices, edges and faces and determine locations of a plurality of 3D elements 4410 using vertices of the mesh 4406. In various embodiments, 3D elements locations may be determined using intersecting points of UV lines on the geometry 4404. The system may then determine a 3D element's 4410 geometry with a set of parameters (block 4436) and generate the 3D elements 4410 on the geometry 4402 using the defined 3D element center and geometry (block 4438). The system may then apply patterns to the surfaces of each 3D element (block 4440).

With respect to designing viewpoint-dependent barrier-based 3D objects, in various embodiments, designers may wish to define a plurality of images to be revealed at desired viewpoints. This can be achieved multiple ways and by applying basic rules in ray tracing.

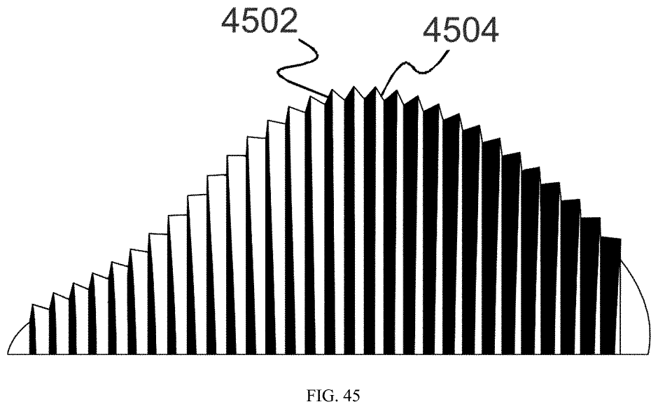

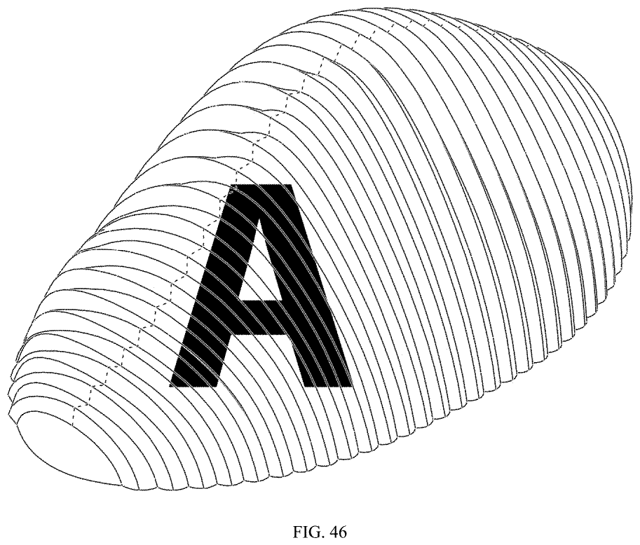

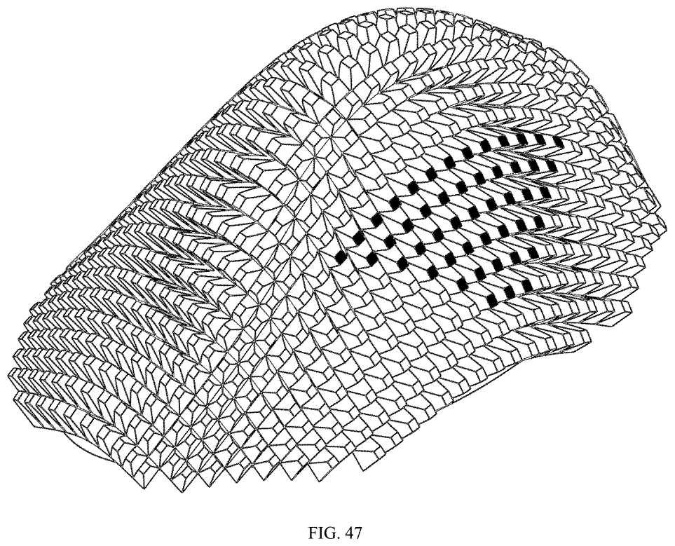

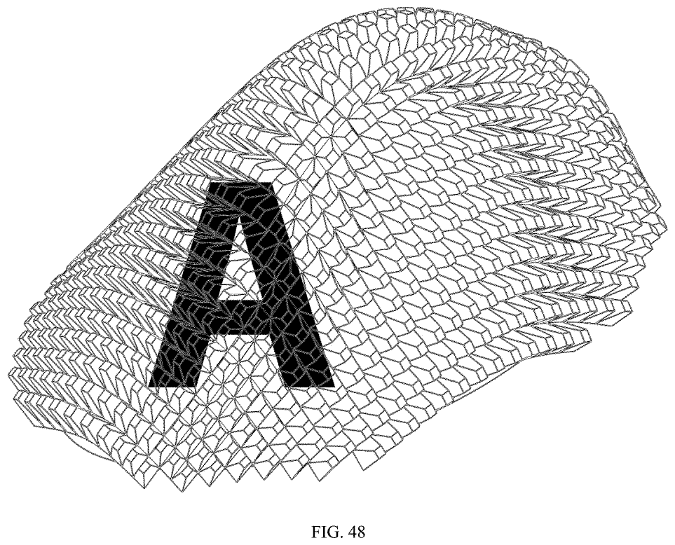

In one embodiment, if the structure and distribution of the 3D elements are already defined, view-dependent display may be achieved by assigning colors/patterns to the 3D elements. Using an exemplary 3D object in FIG. 45, an image may be interlaced and assigned to the surfaces facing the left side of the geometry (the side surface 4502 is facing), another image may be segmented and assigned to the surfaces facing the right side of the geometry (the side surface 4504 is facing). From the viewer's perspective, the two images will be visible from the left and right sides, respectively. However, the patterns of the images may appear discontinuous due to the different surface orientations of the 3D elements. To improve the accuracy of the image display at a specific viewpoint, the proposed system may project a pattern onto the surfaces of the 3D elements, as shown in FIG. 46. From the angle at which the pattern (in this case, a letter “A”) is projected, the viewer will be able to see the full, undistorted original pattern (in this case, a continuous letter “A”). This process can also be applied to barrier-based 3D objects with standalone 3D elements. As shown in FIG. 47, the proposed system can selectively pattern different sides of the 3D elements to create a general pattern on the surface of the geometry. In various embodiments, the system may project a pattern onto the surfaces of the 3D element from a specific viewpoint, as shown in FIG. 48.

In various embodiments, the structure and distribution of the 3D elements may be undefined. In this case, view-dependent display may be achieved by generating the geometry and orientation of the 3D elements in a manner that optimizes the display, and subsequently assigning colors or patterns to the 3D elements. A system is disclosed for precisely controlling the orientation of each face of each 3D element in order to achieve a view-point dependent appearance of an object. The process may include placing a virtual camera to represent a viewpoint, determining the quantity and locations of 3D elements, and the number of faces in each 3D elements using a set of parameters, and generating a face of each 3D element such that all generated faces face the same orientation. The 3D element location and distribution may be determined using UV mapping or mesh vertices. These steps may be repeated to generate all faces of each 3D element, and colors or patterns may be assigned to the faces facing the same orientation.

With respect to manufacturing 3D objects for multi-view displays, in various embodiments, after completing the design of a multi-view 3D object using the aforementioned methods in a digital modeling program, a series of fabrication files can be exported for manufacturing purposes.

The production of lens-based or barrier-based objects often involves the creation of doubly curved transparent and colored material layers, which may be securely attached to one another with matched curvatures in certain embodiments. This process can be difficult to achieve using traditional manufacturing methods, or costly to validate and iterate the design. To address this, various embodiments of the disclosure provide for the use of 3D printing, particularly multi-material 3D printing, as a method for producing lenticular objects and prototyping designs in order to test and verify the lenticular effects before resorting to other manufacturing methods for mass production. Specifically, 3D printing may be used to produce the lenticular object, and prototype the design and validate the lenticular effects before using other manufacturing method for production.

In various embodiments, the disclosure may be used in conjunction with 3D printing to provide greater flexibility and customization in the design process. In other embodiments, the disclosure may be used in conjunction with precision glass moulding and CNC techniques to enhance the accuracy and quality of the final design.

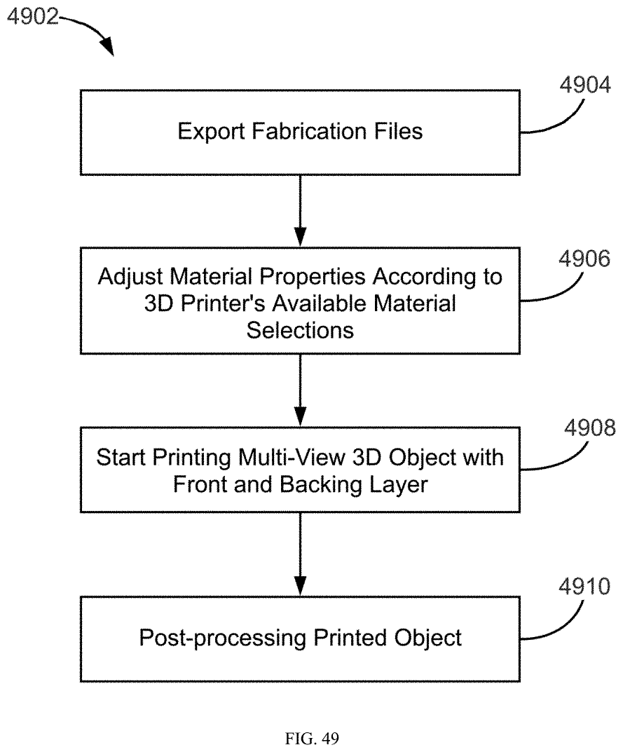

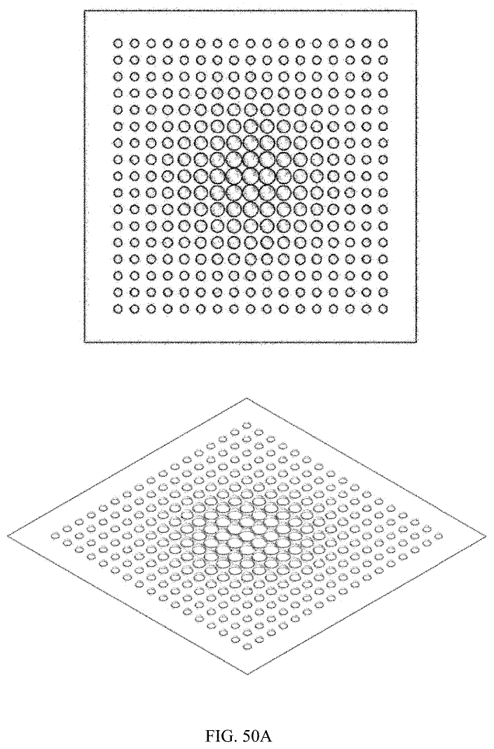

FIG. 49 shows a block diagram of an exemplary process 4902 for using 3D printing to produce a multi-view 3D object. The system may begin at block 4904 the export of multiple fabrication files which contains the 3D model of the designed object. In various embodiments, the fabrication files may also contain material information of each part of the 3D object. The 3D model may include a front lens layer and a backing layer for lens-based objects, or 3D elements/stripes mapped on the surface of a geometry for barrier-based objects. The system then proceeds to block 4906 with adjusting model's material properties to optimize it for 3D printing, a capability possessed by most native printer software. Specifically, the front layer of a lens-based object may be assigned a transparent or translucent material, such as acrylic, resin, or glass, while parts with patterns or images may be assigned an opaque colored material. The 3D object can be printed using rigid or flexible materials depending on the intended application. For some multi-material 3D printers, structures printed at an angle may be partially or fully covered in support material. In the post-processing step (block 4910), the user may remove the support material using tools such as a waterjet machine or acid tank. In various embodiments, to achieve a premiere surface quality on the 3D printed object, the user may polish the surfaces, such as the surfaces of lenses, and apply a few layers of varnish. This process may begin with sandblasting the surfaces of the object to further smooth and refine them. The result is a polished and clear surface with maximum clarity.

In various embodiments, the front layer (comprises either lenses or barriers-based 3D elements) and the backing layer (having a geometry shape) may be produced separately using a combination of 3D printing, CNC, molding, and other manufacturing techniques. For example, the front layer of a lens-based object may be produced using CNC in glass or acrylic, while the backing layer may be 3D printed. In various embodiments, the front lens layer may be produced through 3D printing with a transparent material such as resin, and then combined with a backing layer produced through other manufacturing methods. Different layers of the object may be then combined together to form a full 3D object with multi-view display.

In various embodiments, multi-view display 3D objects may be integrated with moving mechanisms, such as robotic surfaces, so that the dynamic appearance of the surface can be controlled by the machine without requiring the user to change viewpoints manually.

With respect to creating a textile with optical illusion display, in various embodiments, the design system discussed in previous sections may be utilized in textile design to create flexible materials with optical illusions.

In various embodiments, a textile may be designed and fabricated in 3D format using the design system described above. This can be achieved through the use of robotic arms to map the 3D structure onto a 3D surface for wearable design. In various embodiments, the textile may be produced in 3D segmented pieces that are sewn together to form a full garment when worn on the body.

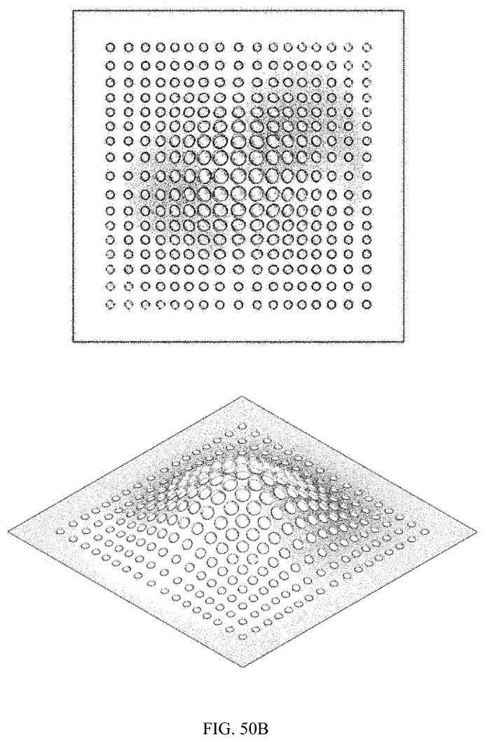

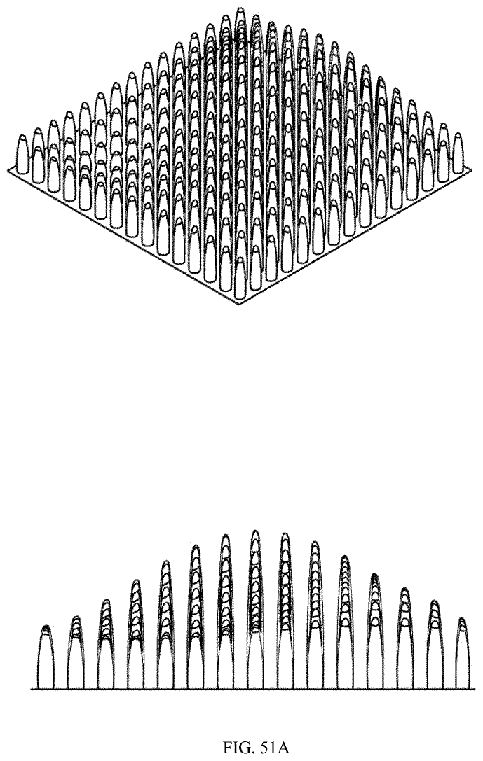

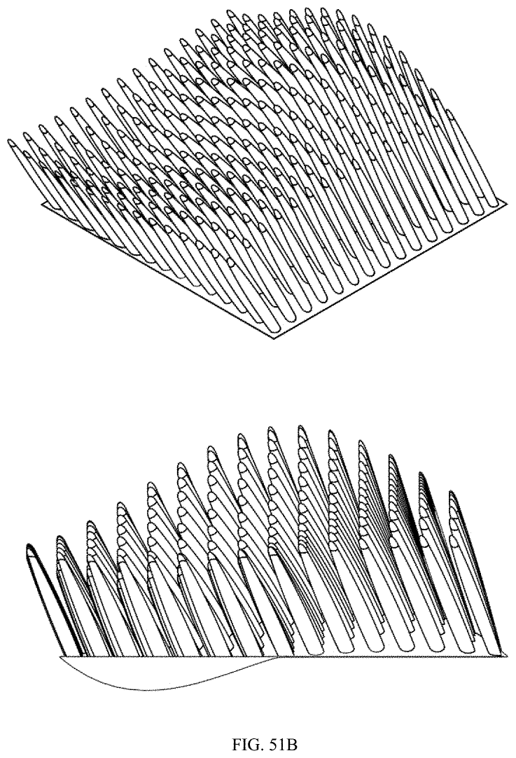

In various embodiments, the exported design file includes 3D fibers arranged on a flat surface and can be produced using flat manufacturing techniques that are widely available. When the resulting fabric is draped or bent into a 3D form, it may reveal dynamic colors due to the distribution of transparent 3D fibers with varying sizes, heights, transparency, stiffness, and spatial density, as illustrated in FIGS. 50A and 50B. Similarly, as shown in FIGS. 51A and 51B, the fabric may reveal dynamic colors when individual opaque 3D fibers with varying sizes, colors, heights, stiffness, and spatial density are distributed on a flat surface and the fabric is draped or bent into a 3D form.

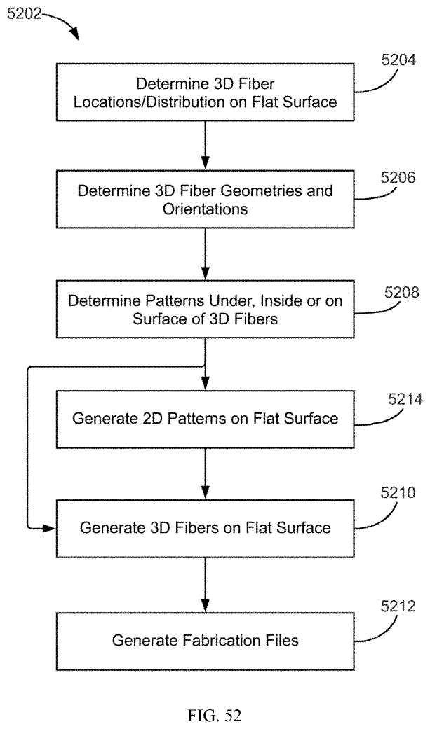

FIG. 52 illustrates an exemplary process for generating a design featuring 3D fibers arranged on a flat surface. The process begins by determining the locations and distributions of the fibers on the surface (block 5204). These fibers may be randomly dispersed or arranged in a specific pattern. The system may then proceed to block 5206 where the geometries and orientations of 3D fibers are determined. The process then proceeds to determining patterns for optical display (block 5208). For lens-based fibers, these patterns may be incorporated within the transparent lenses or located beneath them. For barrier-based opaque fibers, the patterns may be applied to the surfaces of the fibers. With the properties of the 3D fibers defined, the system generates the fibers on the flat surface (block 5210). Optionally, for lens-based object design, 2D patterns may also be generated on the flat surface for future fabrication (block 5214). The process concludes by generating fabrication files for production, which may include multiple 3D model files and files containing 2D images with patterns (block 5212).

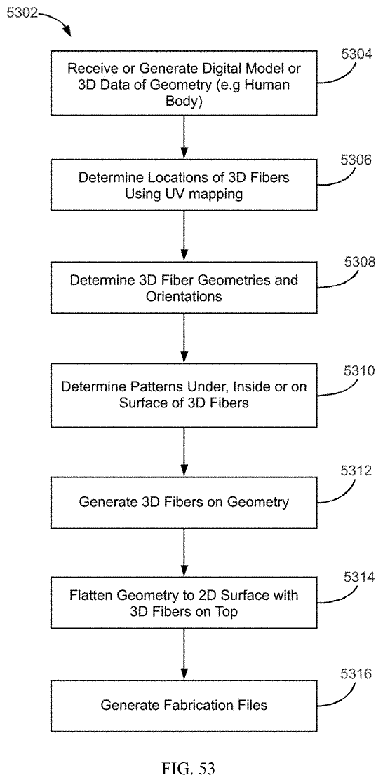

In various embodiments, users may desire for the design to conform to a specific curvature or shape. FIG. 53 presents an exemplary process for generating a multi-view 3D textile design that follows curved surfaces. The process 5302 begins by receiving or generating a digital model or 3D data of a desired geometry (block 5304). For example, this may include 3D body scan data. The system then determines the locations of the 3D fibers using techniques such as UV mapping (block 5306), ensuring that the fiber distribution follows the curvature of the geometry. The system then determines the geometries and orientations of the fibers (block 5308) and patterns for optical display (block 5310). For lens-based fibers, these patterns may be incorporated within the transparent lenses or located beneath them. For barrier-based opaque fibers, the patterns may be applied to the surfaces of the fibers. In some cases, blocks 5308 and 5310 may involve defining multiple images to be revealed at different viewpoints to achieve a viewpoint-dependent display. With the properties of the 3D fibers defined, the system generates the 3D fibers on the geometry (block 5312). The system then flattens the geometry to a 2D surface, mapping the 3D fibers to their relative locations (block 5314) using techniques such as UV unwrapping. The process concludes by generating fabrication files for production, which may include multiple 3D model files and files containing 2D images with patterns (block 5316).

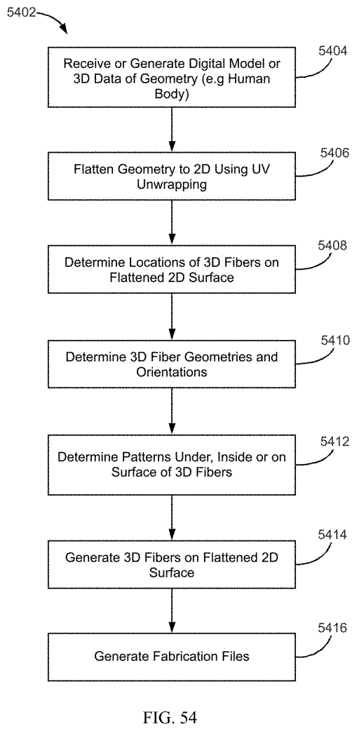

FIG. 54 presents an exemplary process for generating a multi-view 3D textile design that follows curved surfaces, with a slightly different workflow. The process 5402 begins by receiving or generating a digital model or 3D data of a desired geometry (block 5404). For example, this may include 3D body scan data. The system then flattens the geometry to 2D using techniques like UV unwrapping (block 5406). The system then determines the locations of the 3D fibers on the flattened 2D surface using the plurality of UV lines and vertices extracted from UV unwrapping (block 5408), ensuring that the fiber distribution follows the curvature of the geometry. The system then determines the geometries and orientations of the fibers (block 5410) and patterns for optical display (block 5412). For lens-based fibers, these patterns may be incorporated within the transparent lenses or located beneath them. For barrier-based opaque fibers, the patterns may be applied to the surfaces of the fibers. With the properties of the 3D fibers defined, the system generates the 3D fibers on the flattened 2D surface (block 5314). The process concludes by generating fabrication files for production, which may include multiple 3D model files and files containing 2D images with patterns (block 5316).

There are several methods for producing a textile with an optical illusion display, including but not limited to the methods as following. In various embodiments, 3D fibers (either lens-based or barrier-based) may be 3D printed directly onto a fabric that is lying flat on a printer bed. This may involve the user securing the fabric onto the printer bed before starting the printing process. Some printer materials are designed to adhere to fabric without the need for additional adhesives; the user may calibrate the printer bed in advance for this to be successful. This technique can be applied to a wide range of fabrics, including both synthetic and natural fibers. In other embodiments, the 3D fibers may be produced separately using techniques such as CNC machining or moulding, and then attached to the fabric through sewing or adhesion. For barrier-based fibers, the fibers may be produced first and then colored, or they may be produced in color and then attached to the fabric through sewing or adhesion.

With respect to commercial applications, the disclosure includes a solution for designers, engineers, and brands in the fashion, arts, interior décor, automotive design, aerospace design and consumer products industries to create materials with embedded interactions (e.g. view-based interaction and touch-sensitive interaction). This solution is particularly useful for users in the fields of computer-aided design (CAD), 3D printing, and digital rendering, as it allows them to easily translate digital designs into physical reality without being constrained by manufacturing limitations. With this disclosure, designers are able to create a wide range of digital effects in physical form.

In fashion, art, and design industry, the computational design workflow introduced in this disclosure may be used to mimic the dynamism and colors of nature. The disclosure allows for the creation of timeless pieces that engage with the environment and promote the longevity of our surroundings and the integrity of humanity, rather than being focused on short-term trends or single-use items. The disclosure also allows for the manipulation of light refractions on textiles in a way that is similar to the way light is refracted on animal skins. The disclosure uses an algorithm design flow or sequence of a simple element to create unique patterns that cannot be replicated by hand or with traditional technology. The resulting textiles would be able to change appearance based on the angle and intensity of the light source, creating a dynamic and visually interesting effect. The disclosure demonstrates the potential for future customization and physical materiality in these industries.

Authentication is often used for many products, particularly luxury goods. This is typically achieved through the use of a signature mark, pattern, or label on the item that is hard to be copied to perfection. However, some authentication marks can be easily replicated if they are visible or captured in a photograph and then reproduced using standard manufacturing techniques. The disclosure introduces a new method for authenticating goods using a lenticular design that is impossible to duplicate or reproduce without the use of a specific computational model and manufacturing technique. This authentication pattern may be applied to a variety of items, including wine bottles, bags, tags, and other goods, and is designed to be revealed at a precise angle. The disclosure allows for the creation of a secure and unique authentication system that can be used to protect against counterfeiting and ensure the authenticity of luxury products.

The disclosure may open a new era of color, material and/or finish design on consumer products. Instead of relying on digital screens, designers may use physical materials to create dynamic, moving pictures, interactive skins, and content without the need for electrical input.

In various embodiments, the disclosure involves the use of viewpoint-dependent appearance manipulation for medical or user behavior correction. The disclosure allows for customization of the appearance of an object's skin based on the user's height, viewing angle, and habits, by revealing information at desired positions or providing feedback as a therapeutic aid. This may be useful in many medical applications and physical rehabilitation.

One potential application of this disclosure is to train patients with back pain to adopt diaphragmatic breathing instead of chest breathing. A lightweight textile or wearable product could be designed to guide patients in the rhythm of diaphragmatic breathing using a visual guide that shows the movement of the abdomen at different angles. Previously, this type of training relied on sensors and accelerometers with embedded electronics, this disclosure allows for the elimination of electrical components and customization of the wearable to fit the specific body shape of each patient.

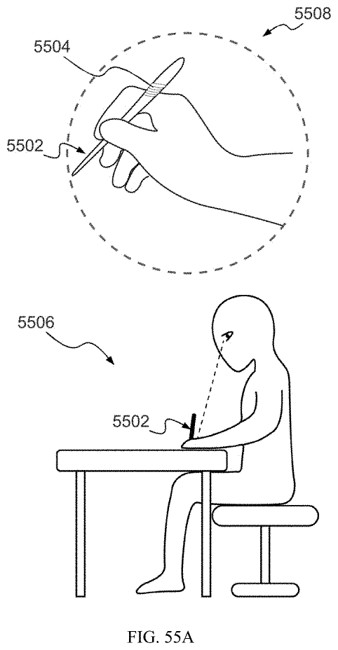

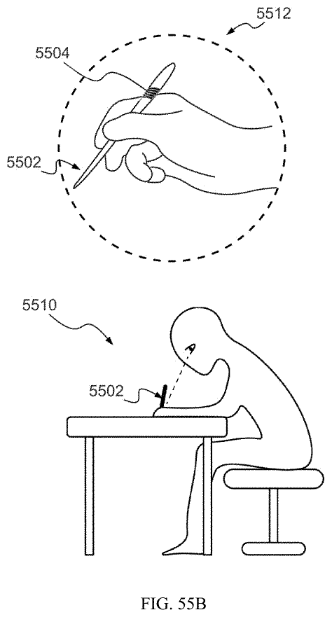

Another example of how to correct a person's sitting posture while writing is provided. As set forth in FIGS. 55A and 55B, a pen 5502 is designed with a lenticular window 5504 that includes a colored strip beneath the lens layer. When viewed from the recommended distance while writing 5506, the lenticular section appears blank, as shown in 5508. If the person looks too close to the paper while writing 5510, the lenticular window 5504 reveals the color, as shown in 5512. This visual reminder may help prevent sight damage that can result from prolonged incorrect sitting posture.

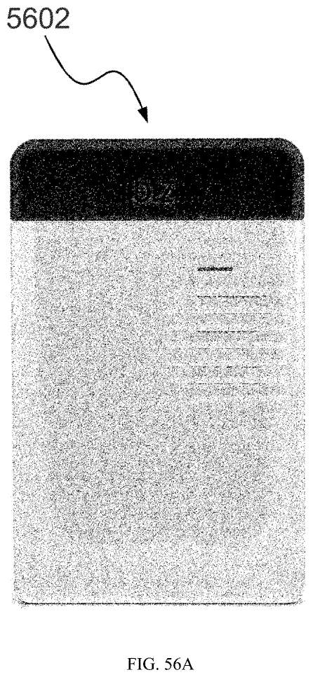

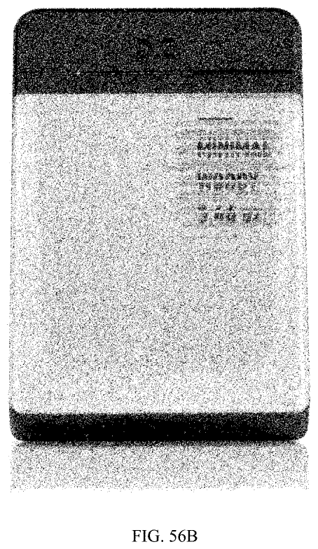

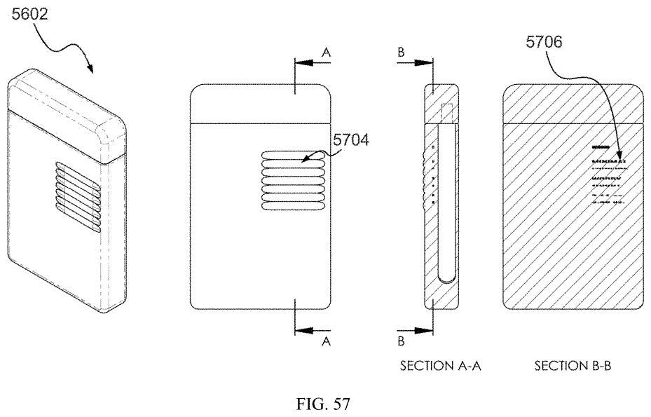

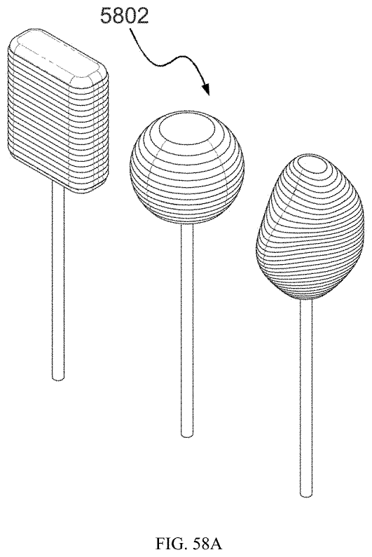

In various embodiments, the disclosure includes a method of creating hidden information to be revealed only at specific angles. The hidden information may be used to protect sensitive information or to show the full nature of a product without any obstructions while maintaining essential context. As shown in FIGS. 56A, 56B and 57, one potential application is in packaging design, where a minimal packaging 5602 may have a fully clear appearance when viewed from the front, but full product information 5706 embedded behind the lenticular window 5704 may be revealed at an observing angle of 20-30 degrees. This design may provide a unique experience in luxury packaging and may be particularly useful for packaging transparent goods such as wine and perfume. The hidden information may also be used in medical product packaging, where sensitive information such as patient names and types of medication can be hidden from unauthorized persons and revealed only to the patient by knowing the specific angle to view the information.

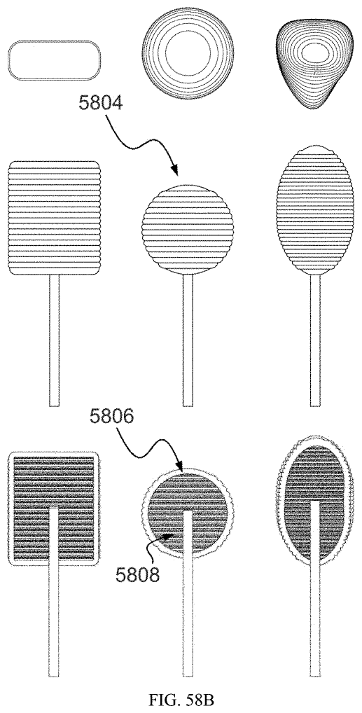

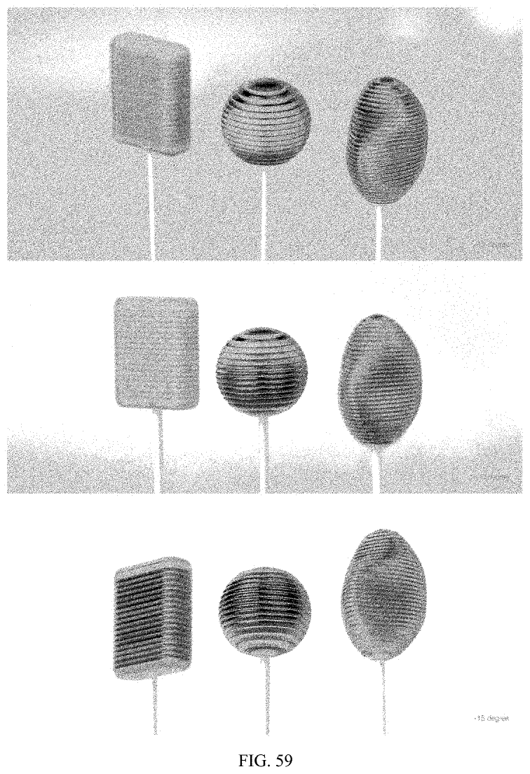

The disclosure may also and puts a playful spin on remarkably untouched industries such as traditional food design, to provide textural experiences and color that can only be created with a digital skin. As shown in FIGS. 58A, 58B and 59, one possible application is an interactive candy or lollipop 5802, which shows the designers' vision for the future of food design: playful, dynamic and highly customizable. The candy head 5804 may include a front layer 5806 made from transparent material (e.g. sugar glass) which covers a backing layer 5808. The front layer 5806 comprises an array of elongated or integral lenses with different heights, curvatures and shapes that provide different refractive behaviors. Different color pixels/patterns/strips embedded in the backing layer 5808 will reveal at different viewpoints. The backing layer is like other conventional candy and may be in any shapes. From different viewing angles, people see a continuous color change that looks like a digital screen playing in a loop. Without any additional medium or harmful chemicals, this lollipop may display dynamically and create a unique experience for kids.

The making of this kind of candy may comprise producing a backing layer in a variety of textures and shapes; making a mold wherein the cavity has the shape of the lenses; fixing the backing layer inside the mold; and pouring a transparent syrup into the mold and letting it caramelize.

The proposed disclosure may also be used to create touch-sensitive interactions without the need for an electrical input, such as a button that changes color when pressed.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The system may allow users to access data, and receive updated data in real time from other users. The system may store the data (e.g., in a standardized format) in a plurality of storage devices, provide remote access over a network so that users may update the data in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The system allows remote users to share data in real time in a standardized format, regardless of the format (e.g. non-standardized) that the information was input by the user. The system may also include a filtering tool that is remote from the end user and provides customizable filtering features to each end user. The filtering tool may provide customizable filtering by filtering access to the data. The filtering tool may identify data or accounts that communicate with the server and may associate a request for content with the individual account. The system may include a filter on a local computer and a filter on a server.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments are expressly incorporated herein by reference and are intended to be encompassed by the present claims. Moreover, it is not necessary for a device or method to address each and every problem sought to be solved by the disclosure for it to be encompassed by the present claims. Furthermore, no element, component, or method step in the disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements, but also to the various system components as described herein. It should be understood that, although exemplary embodiments are illustrated in the figures and described herein, the principles of the disclosure may be implemented using any number of techniques, whether currently known or not. The disclosure should in no way be limited to the exemplary implementations and techniques illustrated in the drawings and described below. Unless otherwise specifically noted, articles depicted in the drawings are not necessarily drawn to scale.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications between disparate computing systems. Middleware components may be contemplated. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to communicate between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices. The AI or ML may store data in a decision tree in a novel way.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

In various embodiments, the server may include application servers (e.g., WEBSPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems).

A web client includes any device or software which communicates via any network, such as, for example any device or software discussed herein. The web client may include internet browsing software installed within a computing unit or system to conduct online communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various support software and drivers typically associated with computers. The web-client may also run MICROSOFT® INTERNET EXPLORER® software, MOZILLA® FIREFOX® software, GOOGLE CHROME™ software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, DISH NETWORK®, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol. Communications originating at a web client may pass through a firewall in order to prevent unauthorized access from users of other networks. Further, additional firewalls may be deployed between the varying components of CMS to further enhance security.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through various data association techniques. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with various embodiments, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the user or other data. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the device along with the associated data, but instead the appropriate action may be taken by providing to the user, at the standalone device, the appropriate option for the action to be taken. The system may contemplate a data storage arrangement wherein the header or trailer, or header or trailer history, of the data is stored on the system or device in relation to the appropriate data.

One skilled in the art will also appreciate that, for security reasons, any databases, systems, devices, servers, or other components of the system may comprise any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet may be contemplated.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

1. An object comprising:
a front lens layer made from at least one of transparent material or translucent material, having a lens with curved surfaces that provide refractive behaviors; and
a backing layer embedded with patterns.

2. The object of claim 1, wherein the front lens layer comprises at least one of elongated lenticular lenses, cylindrical lenses, standalone lenses or spherical lenses.

3. The object of claim 2, wherein the elongated lenticular lenses are arranged in a pattern comprising at least one of parallel, concentric, circular or UV based distribution.

4. The object of claim 1, wherein the front lens layer is made from 3D printing.

5. The object of claim 1, wherein the lens layer comprises a plurality of lenses, wherein the plurality of lens includes different forms and sizes.

6. The object of claim 1, wherein the backing layer is at least one of flat, a fabric or made from a flexible material.

7. The object of claim 1, wherein the backing layer has a plurality of curved surfaces.

8. The object of claim 1, further comprising a fabric layer.

9. The object of claim 1, further comprising a fabric layer, wherein the front layer and the backing layer are printed on top of the fabric layer.

10. A method for designing an object with lenticular effects comprising:
at least one of receiving or generating a digital model of a geometry;
generating a plurality of lenses on the geometry, where the plurality of lenses constitutes a front layer of a lens-covered 3D object;
assigning material properties of the front layer to be at least one of transparent or translucent; and
assigning patterns to a plurality of surfaces of the geometry, where the plurality of surfaces constitutes a backing layer of the lens-covered 3D object.

11. The method of claim 10, further comprising visualizing lenticular effects of the generated 3D object in a rendering software with digital ray tracing simulation capability.

12. The method of claim 10, further comprising offsetting the geometry surface to create a thickness of a substrate below the plurality of lenses.

13. The method of claim 10, wherein the geometry is at least one of flat or curved.

14. The method of claim 10, wherein the plurality of lenses in the front layer have a variety of transparencies and include different refractive behaviors.

15. The method of claim 10, wherein the generating a plurality of lenses on the geometry comprises:
converting the 3D model into a polygon mesh with a plurality of vertices, edges and faces;
using each of the plurality of vertices to determine the center of each lens to create a determined center;
determining a lens geometry with parameters; and
generating a lens using the parameters and locations of the determined center.

16. The method of claim 15, wherein the polygon mesh is a triangular mesh with a plurality of triangle faces, wherein the triangles are equilateral triangles.

17. The method of claim 10, wherein the generating a plurality of lenses on the geometry comprises:
extracting a plurality of UV lines from the geometry;
determining the location of the lenses using the plurality of UV lines;
determining a lens geometry with a set of parameters; and
generating a lens using the set of parameters and locations.

18. The method of claim 10, wherein the generating a plurality of lenses on the geometry and assigning patterns to a plurality of surfaces of the geometry comprises:
offsetting the geometry surface to create a thickness of a substrate below the lenses;
segmenting the geometry with a plurality of cutting planes to create a plurality of backing layer slices;
segmenting the offset geometry with a plurality of cutting planes to create a plurality of offset layer slices;
generating elongated lens geometry on the plurality of offset layer slices with a defined set of parameters; and
assigning at least one of patterns or colors to the backing layer slices.

19. The method of claim 18, wherein the plurality of cutting planes is at least one of parallel, concentric or intersect with each other.

20. The method of claim 10, wherein the assigning at least one of patterns or colors to the backing layer slices comprises:
defining an image to be revealed at a viewpoint of the geometry;
segmenting the image to get a plurality of image regions;
placing a virtual camera to represent a viewpoint;
determining size, shape and location of a focal window under each lens at the viewpoint; and
assigning at least one of colors or patterns to all focal windows under all visible lenses at the viewpoint.

21. The method of claim 20, further comprising averaging the colors of the plurality of image regions.

22. A method for making a 3D object with lenticular effects comprising:
generating a digital 3D model comprising a front layer of lenses and a backing layer;
exporting a plurality of fabrication files from the digital 3D model; and
producing the front layer with a material with transparency and the backing layer.

23. The method of claim 22, wherein the backing layer has at least one of embedded patterns or embedded colors.

24. The method of claim 22, further comprising visualizing lenticular effects of the generated 3D object in a rendering software with digital ray tracing simulation capability.

25. The method of claim 22, wherein the making the 3D object is accomplished by using a multi-material 3D printer.

26. The method of claim 25, wherein the front layer of lenses is printed directly on a fabric.

27. The method of claim 25, wherein the front layer of lenses and the backing layer is printed directly on a fabric.

28. The method of claim 25, wherein the backing layer is produced with at least one of a soft material or a flexible material.

29. The method of claim 22, wherein the producing the front layer is accomplished by using computer control (CNC) in at least one of transparent acrylic or transparent glass.

30. The method of claim 22, further comprising post-processing the model to achieve maximum lens clarity.

31. A method for designing a textile for 3D printing, comprising:
determining locations of a plurality of fibers;
determining geometries and material properties of the plurality of fibers;
determining patterns at least one of under, inside or on the surfaces of the plurality of fibers; and
generating a design file comprising the plurality of fibers defined by a set of parameters.

32. The method of claim 31, wherein the fibers are made from at least one of transparent materials or translucent materials.

33. The method of claim 31, further comprising:
at least one of receiving or generating a digital model or 3D data of a geometry;
determining locations of a plurality of fibers using UV mapping;
determining geometries and material properties of the plurality of fibers;
determining patterns at least one of under, inside or on the surfaces of the plurality of fibers;
generating fibers on the geometry;
flattening the geometry to a 2D surface; and
mapping the fibers to the relative locations of the fibers.

34. The method of claim 31, further comprising:
at least one of receiving or generating a digital model or 3D data of a geometry;
flattening the geometry to a 2D surface using UV unwrapping;
determining locations of a plurality of fibers on the flattened 2D surface;
determining the geometries and material properties of the plurality of fibers;
determining patterns at least one of under, inside or on the surfaces of the plurality of fibers; and
generating fibers on the flattened 2D surface.

35. A candy or lollipop comprising:
a front layer comprises a plurality of at least one of elongated or standalone transparent geometries with defined heights, curvatures and shapes that provide refractive behaviors; and
a backing layer with at least one of colors or patterns.
